(19) United States
(12) Patent Application Publication
(10) Pub. No.: US 2014/0188512 A1
(43) Pub. Date: Jul. 3, 2014

(54) Patient Consent and Confidentiality

(71) Applicant: Medicity, Inc., Salt Lake City, UT (US)

(72) Inventors: Mark B. Parker, West Jordan, UT (US); Kristen McRae, Salt Lake City, UT (US); Michelle Suitor, Salt Lake City, UT (US)

(73) Assignee: Medicity, Inc., Salt Lake City, UT (US)

(21) Appl. No.: 14/108,249

(22) Filed: Dec. 16, 2013

Related U.S. Application Data
(60) Provisional application No. 61/737,661, filed on Dec. 14, 2012.

(51) Int. Cl. G06F 19/00

(52) U.S. Cl. CPC G06F 19/322
USPC 705/3

(57) ABSTRACT

A system and method for managing patient consent. A Master Matching Index (MMI) includes a collection of patient information and identifiers. An MMI adapter is coupled to the MMI for sending queries to the MMI for a health related entity. The MMI adapter comprises a data access manager that includes a lookup module, an authorization engine, an auditing module, a report module and a user interface engine. The user profile engine generates and updates user profile information. The lookup module enables a user to query patient information. The authorization engine determines whether the user has authorization to access patient information. The auditing module logs and monitors user activity. The report module generates reports related to user activity. The user interface engine generates user interfaces for displaying the user profiles, patient profiles and patient data.

### CROSS REFERENCE TO RELATED APPLICATIONS

The present application claims priority, under 35 U.S.C. §119, of U.S. Provisional Patent Application No. 61/737,661, filed Dec. 14, 2012 and entitled “Patient Consent and Confidentiality,” which is incorporated by reference in its entirety.

### BACKGROUND

1. Field of the Invention

The invention relates to managing patient consent and confidentiality. In particular, the invention relates to a system for managing patient consent and confidentiality for accessing patient information in a Master Patient Index.

2. Description of the Related Art

Providing quality health care and related services (e.g., pharmaceutical services, veterinary services) depends on having the ability to reliably access various types of records. In the case of patients, information regarding a particular patient may be needed by various different types of health care related entities. For example, anyone of a hospital, a health care organization, a clinic, a hospital lab, an insurance company, or a pharmacy may need access to particular computerized patient information. Such information retrieval generally occurs by querying a database associated with the health care related entity performing the query. The database typically contains all or part of what is referred to as a Master Patient Index (MPI), which is a collection of patient information and identifiers. Particularly, an MPI is a collection of indexed patient records, where each record contains information about a particular patient. In practice, user-level applications submit patient information to the database, which then uses the MPI to match the incoming data with patient information stored in the database. If a match is found, the record (or pointer thereto) is returned to the querying entity.

While a typical MPI is designed to work within or for a particular health care related entity (e.g., a single hospital, a medical group), including among disparate information systems across the health care related entity, the increased mobility of individuals throughout the overall health care system and the evolution of health care in general requires that patient information be reliably accessible by a local, state, regional or national community of health care related entities.

A problem arises when a physician accesses patient data for a patient that the physician has not yet been assigned. For example, when an emergency room physician treats a patient, the physician needs the patient's medical records without the delay that is incurred when the hospital goes through the normal routines of assigning the patient to the physician. This access to the patient's medical information is referred to as “breaking glass.” Once the emergency is addressed, problems arise with whether the physician continues to have access to the medical records, whether there is an opportunity for abusing this system and whether there should be additional protection of patient information for certain types of patients.

### SUMMARY OF THE INVENTION

The technology described in the specification overcomes the deficiencies and limitations of the prior art at least in part by providing a system and method for managing patient consent. The data access manager manages patient consent and user access to patient information. The data access manager receives patient information from a plurality of sources such as a Master Matching Index (MMI), a data retrieval service, a healthcare data store, health care related entities, etc. The data access manager determines whether a user requesting the patient information is allowed to access the patient information.

In one embodiment, a MMI includes a collection of patient information and identifiers. An MMI adapter is coupled to the MMI for sending queries to the MMI for a health related entity. The MMI adapter comprises a data access manager that includes a lookup module, an authorization engine, an auditing module, a report module and a user interface engine. The user profile engine generates and updates user profile information. The lookup module enables a user to query patient information. The authorization engine determines whether the user has authorization to access patient information. The auditing module logs and monitors user activity. The report module generates reports related to user activity. The user interface engine generates user interfaces for displaying the user profiles, patient profiles and patient data.

In one embodiment, the specification includes a computer-implemented method comprising generating, with one or more processors, a user profile for a patient that includes a patient level describing whether the patient opted-in or opted-out of granular consent options for sharing patient information, responsive to the patient opting-out of sharing information, applying a flag set to the patient information, receiving a request for patient information, determining, with the one or more processors, whether implied consent applies to the request, responsive to implied consent applying to the request, providing the patient information, responsive to implied consent being inapplicable to the request, determining whether an emergency override applies, declining to provide the patient information, responsive to the emergency override applying, determining whether the request is one-time or the request has an end-time and providing the patient information.

In some embodiments, the method further comprises responsive to the request having an expiration and the expiration having occurred, declining to provide the patient information, wherein the user profile also includes a system level consent status for opting-in or opting-out of providing patient data by default, wherein the granular consent option includes consent regarding a data type, a healthcare provider, a time range and a purpose and wherein the data type includes laboratory tests and medications. In another embodiment, the method further comprises: performing an audit of requests for patient information based on a patient, users associated with an organization that requested the patient information or a user that requested the patient information, generating a report based on the audit, and notifying an administrator responsive to a number of requests for patient data exceeding a threshold number during a fixed period of time, wherein the emergency override is for patients within a geographical area. In some embodiments, the patient is automatically opted-out based on being designated as a very important person.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a high-level block diagram illustrating a system for managing patient consent according to one embodiment of the invention.

FIG. 2 is a block-diagram of a data access manager according to one embodiment of the invention.

FIG. 3A is a graphical illustration of a user interface for designating patient consent according to one embodiment of the invention.

FIG. 3B is a graphical illustration of a user interface for designating user rights according to one embodiment of the invention.

FIG. 3C is a graphical illustration of a user interface for accessing patient data according to one embodiment of the invention.

FIG. 3D is a graphical illustration of a user interface for accessing confidential patient information according to one embodiment of the invention.

FIG. 3E is a graphic representation of a user interface for designating user rights for accessing confidential data according to one embodiment of the invention.

FIG. 3F is a graphic representation of another user interface for designating user rights for accessing confidential data according to another embodiment of the invention.

FIG. 3G is a graphic representation 360 of a user interface for designating patient consent according to one embodiment.

FIG. 3H is a graphic representation of a user interface for accessing patient consent audit transaction reports according to one embodiment.

FIG. 3I is a graphic representation of a user interface of a patient consent audit transaction report according to one embodiment.

FIG. 3J is a graphic representation of a user interface of a data access audit log report according to one embodiment.

FIG. 4A is a graphic representation of a scenario for accessing patient data based on absolute consent according to one embodiment.

FIG. 4B is a graphic representation of a scenario for accessing patient data based on absolute consent according to one embodiment.

FIG. 4C is a graphic representation of scenario for accessing patient data based on absolute consent according to another embodiment.

FIG. 4D is a graphic representation of example scenario for accessing patient data by granular consent by practice according to one embodiment.

FIG. 4E is a graphic representation of scenario for accessing patient data based on granular consent by practice according to another embodiment.

FIG. 4F is a graphic representation of a scenario for accessing patient data based on granular consent by type of data according to one embodiment.

FIG. 4G is a graphic representation of a scenario for accessing patient data based on patient consent and time according to one embodiment.

FIG. 4H is a graphic representation of a scenario for accessing patient data based on patient consent and time according to another embodiment.

FIG. 4I is a graphic representation of a scenario for accessing patient data of another physician of record according to one embodiment.

FIG. 4J is a graphic representation of a scenario for accessing patient data by a covering physician according to one embodiment.

FIG. 4K is a graphic representation of a scenario for accessing patient data by a new physician according to one embodiment.

FIG. 4L is a graphic representation of a scenario for accessing patient data by a staff user according to one embodiment.

FIG. 4M is a graphic representation of a scenario for accessing patient data using emergency access according to one embodiment.

FIG. 4N is a graphic representation of a scenario for accessing patient data using emergency access according to another embodiment.

FIG. 4O is a graphic representation of a scenario for accessing patient data using emergency access according to another embodiment.

FIG. 4P is a graphic representation of a scenario for accessing patient data by a health plan user according to one embodiment.

FIG. 5A is a flow diagram illustrating a method for determining whether patient information can be provided to a requestor.

FIG. 5B is a flow diagram illustrating a method for determining authorization and generating a report on patient information access.

### DETAILED DESCRIPTION OF THE PREFERRED EMBODIMENTS

A system and method for managing patient consent are described below. In the following description, for purposes of explanation, numerous specific details are set forth in order to provide a thorough understanding of the invention. It will be apparent, however, to one skilled in the art that the technology described in the various example embodiments can be practiced without these specific details. In other instances, structures and devices are shown in block diagram form in order to avoid obscuring the invention.

Reference in the invention to “one embodiment,” “an embodiment” or “an example embodiment” means that a particular feature, structure, or characteristic described in connection with the embodiment is included in at least one embodiment of the description. The appearances of the phrase “in one embodiment” in various places in the invention are not necessarily all referring to the same embodiment.

Embodiments of the present invention generally relate to a Master Matching Index (MMI). An MMI is an index of records or information that may be matched against queries submitted from across a community of entities needing information of the type contained in the MMI. The community of entities coupled to a particular MMI is herein referred to as an MMI-based system or network. In one or more embodiments, an MMI-based network (or system) and method allows different entities to access a central MMI via matching management specific to each of the entities. In other words, an entity in the network may tune its matching algorithm(s) for improved matching accuracy without affecting the matching accuracy of other entities in the network.

It is noted that the scope of the present invention is not limited to matching patient records as is done with an entity-specific Master Patient Index (MPI). Rather, the principles of the present invention are equally applicable to any type of matching index. For example, an MMI in accordance with one or more embodiments may contain patient records as is done with an MPI. In one or more other embodiments, an MMI may contain information relating to physicians. For example, such an MMI may match against name, Drug Enforcement Administration (DEA) number and/or type. Further, in one or more embodiments, an MMI may contain information relating to insurance plans. For example, such an MMI may match against a plan number and/or address for submission of insurance claims. Further, in one or more embodiments, an MMI may contain information relating to pharmacies. For example, such an MMI may match queries against addresses, phone numbers, and/or type. Further, in one or more embodiments, an MMI may contain information relating to veterinary care. For example, such an MMI may match queries against animal records (e.g., state tag number, last known home address). Further, in one or more embodiments, an MMI may contain information relating to product inventory. For example, such an MMI may contain information relating to product weight, cost, type, and/or use. Thus, although one or more embodiments are described below with reference to matching patient records, it is to be understood that any type of MMI may be used similarly, at least with respect to the distributive, matching and process flow aspects described herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiment of the invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The invention can take the form of an entirely hardware embodiment, an entirely software embodiment or an embodiment containing both hardware and software elements. In a preferred embodiment, the invention is implemented in software, which includes but is not limited to firmware, resident software, micode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the invention is not described with reference to any particular programming language. It will be appreciated that a variety of programming languages may be used to implement the teachings of the invention as described herein.

### System Overview

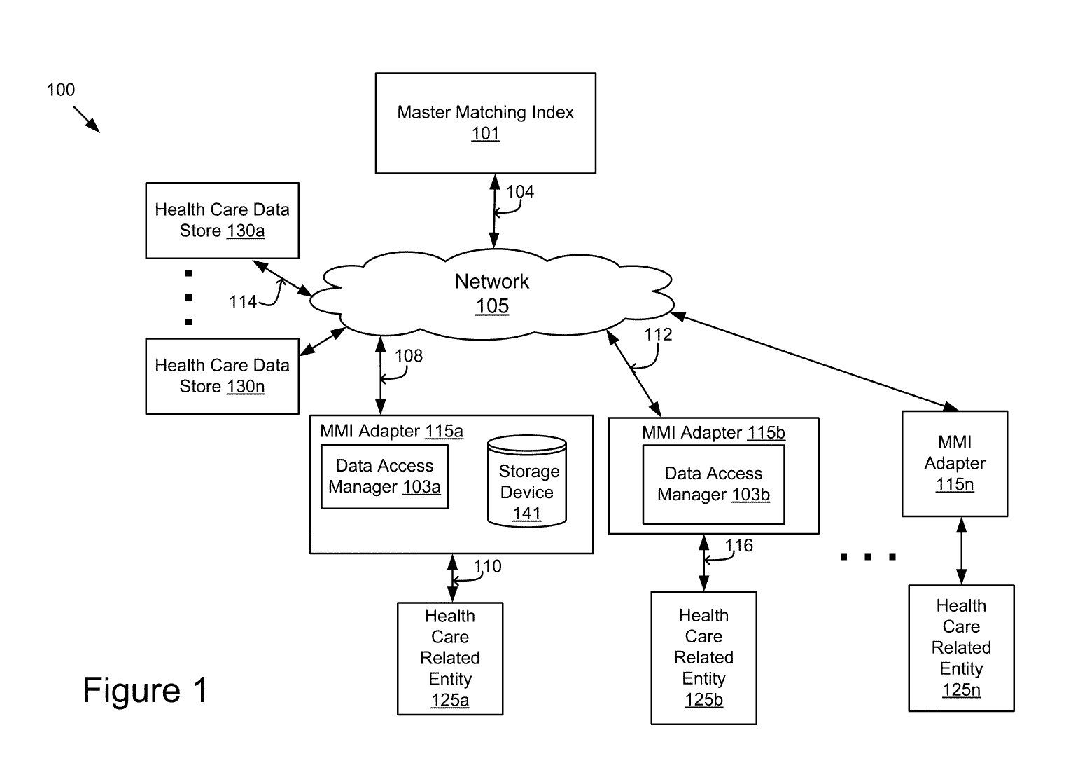

FIG. 1 illustrates a block diagram of a system 100 for managing patient consent in a Master Patient Index according to one embodiment of the invention. In FIG. 1 and the remaining figures, a letter after a reference number, such as “125a” is a reference to the element having that particular reference number. A reference number in the text without a following letter, such as “125,” is a general reference to any or all instances of the element bearing that reference number. In the illustrated embodiment, these entities are communicatively coupled via a network 105.

The illustrated description of a system 100 for managing patient consent includes distributed MMI adapters 115a, 115b . . . 115n that are accessed by health care related entities 125a, 125b . . . 125n, health care data stores 130a . . . 130n and an MMI 101. In the illustrated embodiment, these entities are communicatively coupled via a network 105. The MMI adapters 115a, 115b . . . 115n in FIG. 1 are used by way of example. While FIG. 1 illustrates three MMI adapters 115a, 115b . . . 115n, the description applies to any system architecture having one or more MMI adapters 115n. MMI adapter 115a is coupled to the network 105 via signal line 108. A health care related entity 125a accesses the MMI adapter 115a via signal line 110. MMI adapter 115b is coupled to the network 105 via signal line 112. A health care related entity 125b accesses the MMI adapter 115b via signal line 116.

In one embodiment, the MMI adapter 115a is a hardware server, such as one powered by Medicity®. The MMI adapters 115a, 115b . . . 155n server as interfaces to health care entities 125a, 125b . . . 125n. Those skilled in the art will note that while a distributed MMI adapter 115 and its associated health care related entity 125 may reside on the same system, this need not always be the case. For example, in one or more embodiments, the distributed MMI adapter 115 may be provided as a remote interface to the associated health care related entity 125.

The MMI adapter 115a comprises a data access manager 103a and a storage device 141. The MMI adapter 115b comprises a data access manager 103b and a storage device (not shown). The data access managers 103a, 103b manage patient consent and user access to healthcare information. The storage device 141 stores data managed by the data access manager 103a, such as the identity of users and their patient consent forms.

The health care entities 125 maintain separate systems with their own information and access patient information stored by other entities via the network 105. Health care entities 125 include, but are not limited to, a hospital, a specific department within a hospital (e.g., admissions, laboratory, radiology), a clinic, a physician's office, a pharmacy, a health insurance company, a health care organization (e.g., a Health Maintenance Organization (HMO), a hospital-associated research lab, etc. A health care related entity 125 needing to locate a particular patient record submits a query to the respective MMI adapter 115. The query is embodied in a thread configured by the respective MMI adapter 115 and the thread is transmitted to the MMI 101. Thus, when one of the health care related entities 125 submits a query for a patient record, the query is actually sent as a set of instructions describing how to look for the patient record in the MMI 101.

The MMI 101 includes a collection of patient information. For example, the MMI 101 is a collection of indexed patient records, where each record includes a patient identifier which uniquely identifies a patient and data associated with a patient identifier describing health care information associated with the patient identified by the patient identifier. The MMI 101 is coupled to the network 105 via signal line 104. In one embodiment, the MMI 101 comprises a computing device, such as a server, desktop computer or laptop, including a database having one or more patient identifiers and data associated with a patient identifier describing health care data, such as test results, demographic information, billing information, prescription history or similar data associated with the patient identifier.

In another embodiment, the MMI 101 includes a data retrieval service that fulfills data request and one or more health care data stores 130a . . . 130n that includes health care data associated with the patient identifier. Therefore, the MMI 101 matches data from the data retrieval service with one or more patients, allowing retrieval of health care data associated with a patient from a database stored on the MMI 101 or from a health care data store 130 identified by the MMI 101. Although, the data retrieval service is described as part of the MMI 101, in various embodiments, the MMI 101 and the data retrieval service 107 are on separate servers.

One or more health care data stores 130a . . . 130n communicate with the MMI 101. A health care data store 130a comprises a computing device or other storage device including health care data, such as clinical results, prescription history, insurance or billing information, demographic information or other data associated with providing health care services or products to a patient. For example, health care data store 130a comprises a clinical data catalog including clinical data, a medical insurance database including billing information for one or more patients, a record database including demographic information associated with one or more patients or other store of information applicable to health care services or products provided to one or more patients. Therefore, a health care data store 130a includes health care data associated with one or more patients, allowing retrieval of data associated with a particular patient. The health care data store 130a is coupled to the network 105 via signal line 114. In one embodiment, the health care data storage 130 is stored locally with the health care related entity 125.

The network 105 is a conventional type, wired or wireless, and may have any number of configurations such as a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In yet another embodiment, the network 105 may be a peer-to-peer network. The network 105 may also be coupled to or includes portions of a telecommunications network for sending data in a variety of different communication protocols. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, email, etc.

### Data Access Manager 103

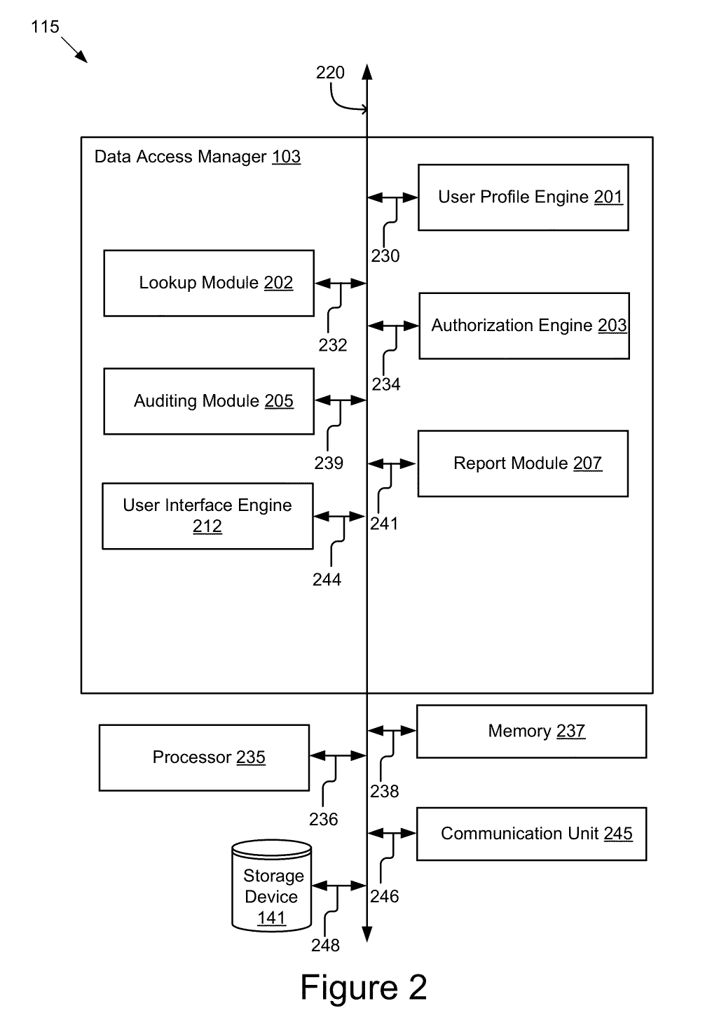

Referring now to FIG. 2, the MMI adapter 115 comprises a data access manager 103, a memory 237, a processor 235, a communication unit 245 and a storage device 141 that are each connected to the bus 220. The bus 220 may represent one or more buses including an industry standard architecture (ISA) bus, a peripheral component interconnect (PCI) bus, a universal serial bus (USB), or some other bus known in the art to provide similar functionality.

The processor 235 comprises an arithmetic logic unit, a microprocessor, a general purpose controller or some other processor array to perform computations and provide electronic display signals to a display device. The processor 235 is coupled to the bus 220 for communication with the other components via signal line 236. Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 237 stores instructions and/or data that may be executed by processor 235. The memory 237 is coupled to the bus 220 for communication with the other components via signal line 238. The instructions and/or data may comprise code for performing any and/or all of the techniques described herein. The memory 237 may be a dynamic random access memory (DRAM) device, a static random access memory (SRAM) device, flash memory or some other memory device known in the art. In one embodiment, the memory 237 also includes a non-volatile memory or similar permanent storage device and media such as a hard disk drive, a CD-ROM device, a DVD-ROM device, a DVD-RAM device, a DVD-RW device, a flash memory device, or some other mass storage device known in the art for storing information on a more permanent basis.

The communication unit 245 transmits and receives data to and from the MMI 101, health care data stores 130a . . . 130n and other MMI adapters 115. The communication unit 245 is coupled to the bus 220 via signal line 246. In one embodiment, the communication unit 245 includes a port for direct physical connection to the MMI 101 or to another communication channel. For example, the communication unit 245 includes a USB, SD, CAT-5 or similar port for wired communication with the user device 115. In another embodiment, the communication unit 245 includes a wireless transceiver for exchanging data with the MMI 101 or any other communication channel using one or more wireless communication methods, such as IEEE 802.11, IEEE 802.16, BLUETOOTH® or another suitable wireless communication method.

In yet another embodiment, the communication unit 245 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the communication unit 245 includes a wired port and a wireless transceiver. The communication unit 245 also provides other conventional connections to the network for distribution of files and/or media objects using standard network protocols such as TCP/IP, HTTP, HTTPS and SMTP as will be understood to those skilled in the art.

In one embodiment, the data access manager 103 comprises a user profile engine 201, a lookup module 202, an authorization engine 203, an auditing module 205, a reporting module 207 and a user interface engine 212.

The user profile engine 201 is software including routines for generating user profiles. In one embodiment, the user profile engine 201 is a set of instructions executable by the processor 235 to provide the functionality below for generating user profiles. In another embodiment, the user profile engine 201 is stored in the memory 237 and is accessible and executable by the processor 235. In either embodiment, the user profile engine 201 is adapted for cooperation and communication with the processor 235 and other components of the data access manager 103 via signal line 230.

The user profile engine 201 generates user profiles for patients. The user profile includes the name of the patient, a social security number, date of birth, demographic information (e.g. age, location, ethnicity, etc.) and pointers to the patient information stored in the Master Matching Index 101. In some embodiments, the user profile engine 201 includes an image of a signed consent form provided by each patient. The user profile engine 201 classifies patients on different consent levels that define a basic set of functional and data type access authorities. Many of these security attributes can be adjusted individually to create patients with authority profiles that have been tailored to meet user and environment specific needs. The user profile engine 201 generates consent status based on three different levels: a system level, a patient level and a user level.

The system level applies a system-wide consent of opt-in or opt-out for all the information. In some embodiments, the user profile 201 includes a location of the patient and determines the system level based on the patient's location. For example, where a state requires that the consent status be opt-out as a default, the user profile 201 automatically makes the system consent status opt-out for any patients living in that state. In another embodiment, the system level can include an option for a patient to have access to their information be limited because the patient is a Very Important Person (VIP). For example, members of Congress can have consent for their confidential patient information be opted-out.

The patient level allows a user to provide granular options for consent status for different areas of patient information. In one embodiment, granularity refers to data type, provider, time range and purpose of the data. Data type includes lab tests, doctor notes, medications, etc. For example, the type of data may be a pregnancy test for a teen or a Human immunodeficiency virus (HIV) test for a person. In the embodiment, the authorization engine 203 comprises a catalog of data that includes types of data that a user cannot view unless the user has special privileges to view the data. The provider includes different places where the patient seeks medical treatment. For example, the patient can opt-out of sharing all information from a drug treatment clinic, but can opt-in to all information from a general practitioner.

The time range can be set a specific period of time. For example, the indicator may indicate an opt-in status for a period of time (e.g., 2 months). When the period of time (e.g., 2 months) expires, the opt-in status changes to an opt-out status. In another embodiment, the indicator indicates a consent status based on an age of the patient. For example, an opt-in status for a patient who is a minor (e.g., person under 18 years old) may change to an opt-out status based on the patient becoming an adult (e.g., person 18 years old and older). In another embodiment, the consent status changes to a system default.

The user level includes patient and data access for users. Users are medical staff including administrators, physician assistance, nurses, doctors, etc. A user can obtain access to data with opt-out consent when implied consent or an emergency override applies. Implied consent occurs, for example, when a patient provides consent for having blood drawn for performing laboratory tests. The patient has provided implied consent for the patient's physician to review the results of the laboratory tests. An emergency override applies when a patient appears unconscious in an emergency room of a hospital. The patient's records, however, the physician can break glass and access the data due to the emergency. The emergency override applies when a geographic specific emergency is called, for example, when a governor declares an emergency due to a hurricane.

The user profile engine 201 transmits instructions for the user interface engine 212 to generate graphical data for displaying a user interface to the user for registering the user. In the embodiment, the user profile information is for at least one of updating or adding a user profile. The user profile information includes information for allowing or denying access to patient information including confidential information and non-confidential information. For example, the patient can opt-in to having the patient's information exchanged over the network 105 by providing an affirmative authorization by signing a consent form. The patient can also opt-in with restrictions, such as identifying types of information that the patient wants kept confidential. For example, confidential and non-confidential patient information. The patient can also opt-out of having the patient's information exchanged over the network 105 by formally requesting that the data not be exchanged. The patient can also opt-out without exceptions, which results in the patient information being exchanged and the consumer being notified through mailings, brochures, posted notices or other means.

The lookup module 202 is software including routines for enabling a user (via a client device) or a third-party application to query data. In one embodiment, the lookup module 202 is a set of instructions executable by the processor 235 to provide the functionality below for receiving a request from a user for patient data, transmitting a query to a MMI 101 or one or more health care data stores 130a . . . 130n and receiving patient data from the MMI 101 or one or more health care data stores 130a . . . 130n. In another embodiment, the lookup module 202 is stored in the memory 237 and is accessible and executable by the processor 235. In either embodiment, the lookup module 202 is adapted for cooperation and communication with the processor 235 and other components of the data access manager 103 via signal line 232.

In one embodiment, the lookup module 202 may be used to transform/translate incoming data from an associated health care related entity to a data format specified or otherwise accurately recognizable by the MMI 101. For example, in a case where the associated health care entity stores dates in month/day/year format and the MMI 101 manages dates in day/month/year format, the lookup module 202 may perform the proper date format conversion between the associated health care related entity and the MMI 101. Further, in another example, information specified with dashes (e.g., insurance identifies, social security numbers) may be converted by the lookup module 202 to a format without dashes (and vice-versa) depending on how data is stored in the MMI 101.

Moreover, the lookup module 202 may be used to resolve competing returned matches. For example, if the MMI 101 is unable to automatically match a patient against records, multiple possible matches may be returned to the lookup module 202, in which case, the lookup module 202 may be used to select one of the returned possible matches. In one or more embodiments, the lookup module 202 may be manually used by a user to resolve a mismatch or multiple returned matches. Further, in one or more embodiments, the lookup module 202 may be configured to automatically resolve a mismatch or multiple returned matches based on some predetermined logic.

Further, the lookup module 202 may be used for the generation of the algorithms/rules for filtering patient data from the MMI 101. This may be accomplished by using performing patient matching with known sample data (representing data from the associated health care related entity). For example, sample data representing 10 known patients may be patient matched, and then, using the lookup module 202, a determination may be made for generating or adjusting algorithms/rules in the lookup module 202 to improve matching accuracy. Thus, in general, such “training” essentially comprises a feedback loop involving feeding sample data and testing patient matching results to adjust the lookup module 202. Further, in one or more embodiments, the sample data may be periodically or regularly changed so as to test different algorithms/rules in the lookup module 202. Further still, in one or more embodiments, the algorithms/rules in the lookup module 202 may be adjusted, whereupon sample data is patient matched to aid in determining which algorithms/rules result in a desired level of patient matching.

The authorization engine 203 is software including routines for authorizing access to and retrieving patient data from the storage device 141 or the master matching index 101. In one embodiment, the authorization engine 203 is a set of instruction executable by the process 235 to provide the functionality below for determining whether a user can access or update patient data. In another embodiment, the authorization engine 203 is stored in the memory 237 and is accessible and executable by the processor 235. In either embodiment, the authorization engine 203 is adapted for cooperation and communication with the processor 235 and other components of the data access manager 103 via signal line 234. The authorization engine 203 supports reading data in one or more formats. For example, the authorization engine 203 supports data formats including Health Level Seven (HL7) and eXtensible Markup Language (XML).

The authorization engine 203 retrieves user profile information from the user profile engine 201 by sending a patient identifier to the user profile engine 201. In one embodiment, the storage device 141 stores user profile information. The storage device 141 transmits the user profile information to at least one of the authorization engine 203 and the user profile engine 201.

The authorization engine 203 determines whether a user or a third-party application has a right or rights to access patient information based on the user profile and attributes of the user that requested the data. For example, the authorization engine 203 determines that the user requesting the data is a physician of record for the patient and, as a result, provides the user with information obtained from the lookup module 202. The user profile indicates whether a patient opted-in to sharing patient information (with or without exceptions) that is associated with the patient or whether the patient opted-out (with or without restrictions). In one embodiment, the user profile is associated with the patient and the user profile applies to all information associated with the patient. For example, the authorization engine 203 determines from the user profile that a patient opted-in to sharing the patient's information with other health care entities 125 in the network 105. Therefore, all health care data, such as clinical results, prescription history, insurance or billing information, demographic information or other data associated with providing health care services or products to a patient is accessible to a user that queried the patient. In some embodiments, the physician that generates the health care data controls the indicator. For example, a psychiatrist chooses whether the psychiatrist's notes are accessible to other physicians in the system. In some other embodiments, the authorization engine 203 applies state regulations to the opt-in rules regardless of patient consent, such as when a state law prohibits sharing information of minors.

In another embodiment, the user profile is associated with at least a part of clinical data associated with a patient. For example, a patient opted not to share lab work results from the patient's general doctor with a specialist that the patient sees. The authorization engine 203 examines the user profile and determines that the specialist does not have rights to access the lab work results.

In yet another embodiment, the authorization engine 203 authorizes access to patient data based on a relationship between the user or a third-party application and the patient. For example, the user is a primary care physician for the patient or a person associated with the physician and the data is lab work for the patient. Therefore, the authorization engine 203 grants access to the lab work because the user has an authorized relationship with the patient. The authorization engine 203 manages authorization based on direct and indirect documentation where a recorded patient consent form is direct and relationships indicated through HL7 transactions are indirect. HL7 transactions normally identify the requesting doctor or organizational component. This information is an indirect consent for the doctor or organizational component to access unrestricted portions of a patient's health record. Given the nature of HIE environments, this may be the primary method of authorizing access to patient information.

In yet another embodiment, the authorization engine 203 denies access to patient data based on a status associated with the patient. For example, Very Important People (VIPs) such as high ranking corporate employees, diplomats, government officials, celebrities, etc. can have a certain status that protects the patient data from being widely distributed. For example, a government official or a celebrity's information is inaccessible because they are public figures. Categories and levels associated with confidential or VIP restrictions on patient data include: business, clinician, individual, low, normal, restricted, very restricted, employee, unwed mother, substance abuse related, HIV related, psychiatry related, sexual and domestic violence related, celebrity, sensitive and taboo.

In one embodiment, the authorization engine 203 gives physicians and staff associated with the provider access to all patient data after the user breaks the glass. In another embodiment, the authorization engine 203 restricts all or part of a patient record if the patient is a VIP or the patient data is marked as being confidential. In another embodiment, the authorization engine 203 restricts access to confidential information to users with the appropriately high security level. A user can request restriction of access to their patient information. For example, the staff cannot access information about a patient's pregnancy test or HIV test if the staff is not associated with the patient or provider. In yet another embodiment, the physicians can see all information for a VIP but the staff is limited from accessing all information. In yet another embodiment, the authorization engine 203 prevents the user from accessing patient information because the time limit for providing access to the patient data has expired.

The authorization engine 203 marks patient data as being associated with a VIP or as confidential in response to receiving a message indicator. The message indicator can be sent in a HL7 segment. Depending upon the type of HL7 segment, all or a portion of the patient data is marked as being confidential. For example, the authorization engine 203 receives an HL7 transaction with a patient data 1 (PD1) segment for flagging the entire patient record with a VIP status and, in response, the authorization engine 203 prevents the patient record from appearing in search results unless the user has security rights to view VIP status or the user is a physician for the patient. The authorization engine 203 does not remove the VIP status unless the request for removal is received from the same source that originally sent the VIP status. The following is an example list of HL7 confidential indicators:

| | | |
|---|---|---|
| Diagnosis | DG1:18 | Confidential Indicator |
| Guarantor | GT1:38 | Publicity Code |
| Guarantor | GT1:39 | Protection Indicator |
| Guarantor | GT1:57 | VIP Indicator |
| Insurance | IN1:53 | VIP Indicator |
| Insurance | IN2:36 | Publicity Code |
| Insurance | IN2:37 | Protection Indicator |
| Next of Kin | NK1:22 | Publicity Code |
| Next of Kin | NK1:23 | Protection Indicator |
| Next of Kin | NK1:39 | VIP Indicator |
| Patient Demographics | PD1:11 | Publicity Code |
| Patient Demographics | PD1:12 | Protection Indicator |
| Patient Demographics | PD1:13 | Protection Indicator |
| | | Effective Date |
| Patient Visit | PV1:16 | VIP Indicator |
| Patient Visit | PV2:21 | Visit Publicity Code |
| Patient Visit | PV2:22 | Visit Protection Indicator |
| Common Order | ORC:28 | Confidentiality Code |
| Transcription Document | TXA:18 | Document |
| Header | | Confidentiality Status |
| Third-party CCD or | N/A | Document |
| created CCD | | Confidentiality Status |

In another example, only a portion of the patient record is marked as having a VIP status when the authorization engine 203 receives an HL7 transaction where the VIP indicator is at the encounter level in a patient visit 2 (PV2) segment or it is sent as a confidential diagnosis in a diagnosis 1 (DG1) segment. A VIP status sent at the encounter level removes everything associated with a specific encounter from view (including orders, results, reports, notes, diagnosis, etc.) unless the user has the security rights to view VIP information or is a physician for the encounter. Everything else in the patient's record remains visible.

In yet another example, an order and not the patient's entire record is marked as having a VIP status when the authorization engine 203 receives a common order segment (ORC). The authorization engine 203 assigns the order and everything associated with the order as confidential and renders the order unsearchable unless the user has security rights to view confidential information or is the physician on the order.

In yet another embodiment, the authorization engine 203 receives a request from a user or a third-party application for emergency access to data that a patient has not consented to sharing. In this embodiment, the user exercises a break glass policy to access patient information. Breaking glass refers to the act of a physician accessing a patient's information when the physician has not yet been assigned to the patient and/or the patient has not given consent to access all or part of the patient's clinical data. As a result, even if the patient opted out of having the patient's data shared among physicians and/or staff, the breaking glass overrides the opt-out option.

For example, in a public health emergency where there is an emergency disease outbreak or a natural disaster, a physician may need access to patient data, such as clinical history, medications, lab work etc. to treat the patient. Alternatively, the physician may need to ignore patient consent and identify effected patients during an emergency, such as a disease outbreak. The authorization engine 203 transmits the requested data during the emergency. In one embodiment, the authorization engine 203 records the reason for breaking glass, including the nature of the emergency and whether the breaking glass was prompted by reporting information to public health officials as required by law. In one embodiment, the breaking glass policy includes an option for automatically giving a group of physicians access to patient information during an emergency, such as a hurricane. This is referred to as a Health Information Exchange (HIE)-wide emergency override. Other breaking glass examples occur when the physician needs the patient's information and it is difficult to request permission, such as when the physician is acting as a consultant for the patient's primary physician.

In one embodiment, the authorization engine 203 grants access to all or part of patient data. In another embodiment, the authorization engine 203 requires at least one of a provider or a physician that accesses the data, an access period and a reason for accessing data from the user. The identity of the requestor can be further identified as an attending, admitting or consulting physician or staff, which is used to associated a nurse or other healthcare provider with a patient. In yet another embodiment, the authorization engine 203 instructs the user interface engine 212 to generate graphical data of a patient consent form that that patient must print and sign before access is granted. The authorization engine 203 transmits information about the location of the physical document to the auditing module 205, which logs the location as part of the consent authorization documents.

Once the authorization engine 203 grants the user or the third-party application access to the patient data, the authorization engine 203 stores the request and/or the required information in storage device 141 and notifies the lookup module 202 that the patient's data can be present in search results for the period of time that the patient's data is accessible to the user. The user can access the patient data one time, in a limited capacity, is stopped from further accessing the data or at a later time if the time is still in the access period. In one embodiment, the breaking glass policy is only provided to certain users or users associated with certain roles. For example, the physician has access to a policy in an emergency situation. However, regular staff would not be permitted to use the policy.

In some instances, the authorization engine 203 performs anonymizing and de-identifying of the patient data. This data can then be used for clinical trials and other methods without having to be concerned about patient consent because the data is anonymous. In many circumstances, the patients are still notified that their information could be used anonymously so that the patients have informed consent. In another embodiment, the authorization engine 203 also generates an identifier linking the information back to the original patient. The authorization engine 203 can later identify the user through a restricted identification process. In this embodiment, the authorization engine 203 may employ the same restrictions for patient consent and breaking glass that are described above.

The auditing module 205 is software including routines for logging and monitoring user activity. In one embodiment, the auditing module 205 is a set of instructions executable by the processor 235 to provide the functionality below for tracking data access. In another embodiment, the auditing module 205 is stored in the memory 237 and is accessible and executable by the processor 235. In either embodiment, the auditing module 205 is adapted for cooperation and communication with the processor 235 and other components of the data access manager 103 via signal line 239.

The auditing module 205 creates a common event log to record each time a user accesses or modifies a patient record or piece of clinical information. For example, the auditing module 205 tracks when a user changes or adds patient/clinical data. In another example, the auditing module 205 logs user activity when a user queries/requests patient data or views the patient data. For example, the auditing module 205 logs when the user breaks glass and records the reason given if one is provided. The auditing module 205 logs the user identifier and context, the event data and time, the event type, the patient identified and context, the encounter context, the data type, the data descriptor and event-specific information. The auditing module 205 stores the user activity in storage device 141. Those skilled in the art will note that other user activities are recorded by the auditing module 205. The storage device 141 is coupled to the bus 220 via signal line 248.

In another embodiment, the auditing module 205 determines inappropriate data access by a user. The auditing module 205 analyzes data access to determine patterns of inappropriate access by the user. For example, the auditing module 205 determines that a user broke glass too many times over a predetermined threshold for a period of time. In one embodiment, the auditing module 205 notifies an administrator responsive to the user exceeding the threshold. In another embodiment, the auditing module 205 determines that a user broke glass too many times on certain types of patients. For example, the user broke glass too many times for VIPs, such as celebrities, etc.

The report module 207 is software including routines for generating reports. In one embodiment, the report module 207 is a set of instructions executable by the processor 235 to provide the functionality below for generating reports. In another embodiment, the patient report module 207 is stored in the memory 237 and is accessible and executable by the processor 235. In either embodiment, the report module 207 is adapted for cooperation and communication with the processor 235 and other components of the data access manager 103 via signal line 241.

The report module 207 generates reports related to user activity. The report module 207 generates a report based on information logged by the auditing module 205. For example, the report module 207 generates a report that is related to a history of user access to patient information. The report includes instances of breaking glass and information about patient consent including the patient consent documents discussed above with reference to the authorization engine 203. In one embodiment, the report module 207 generates the report for regular review by a security officer and the report is forwarded to peer review or regulatory organizations for action as appropriate. In another embodiment, the report is displayed to an administrator for determining whether inappropriate access by a user occurred. In one embodiment, the report indicates how many times a user broke glass during a period of time. In another embodiment, the report indicates user access to a specific set of patients.

The report module 207 configures the report to include a variety of data including: a user login history, physician logins, patient chart access, patient consent audit transactions, clinical inbox activities, a breaking glass audit log, deliveries, patient merge clinical data repositories, patient move/link MPIs, community document activities, medication history queries and organization or user rights logs. The user login history returns a login history for all users in a specified organization, for a specified user or a number of active users in a specified organization. The physician logins summarizes the annual logins for all physicians in a single repository. The patient chart access provides patient chart access for all users in a specified organization, for a specified patient or for a specified user. The patient consent audit transactions provides audit transactions for a specified organization, for a specified patient or for a specified user. The clinical inbox activity summarizes clinical inbox actions taken by users in a specified organization, summarized which users have taken action on a specified patient's information from the clinical inbox or summarizes which patients have had clinical inbox actions taken by a specified user. The break glass audit log provides a break glass audit log for long and short term uses for all the users in a specified organization, for a specified user or a specified patient, and provides a list of who broke glass for a long or short term to see patients of a specified provider. The delivery report identifies the delivery method and location for each result for a specified organization or for each result for a specified patient. The patient move/link MPI reports returns move and link details by a user or provides a moves and links summary in response to manual input. The community document activity summarizes continuity of care document (CCD) actions taken by users in a specified organization, by which patients have had CCD actions taken by the specified user or by which users have taken action on the specified patient's information using CCDs. The medication history queries summarizes medication history queries initiated by users in a specified organization or by a specified user, and summarizes which users have initiated medication history queries on a specified patient. The organization and user rights log tracks who created or changed organization or user rights as well as which users viewed management reports.

In one embodiment, the report module 207 generates a report for public health officials of instances where a public health emergency occurred. The report contains a list of the people whose information was accessed in addition to any type of patient consent that is part of the record or instances where the physician had to break glass to treat the patient.

### Example User Interface Engine

The user interface engine 212 is software including routines for generating graphical data for displaying a user interface. In one embodiment, the user interface engine 212 is a set of instructions executable by the processor 235 to provide the functionality below for generating a user interface. In another embodiment, the user interface engine 212 is stored in the memory 237 and is accessible and executable by the processor 235. In either embodiment, the user interface engine 212 is adapted for cooperation and communication with the processor 235 and other components of the data access manager 103 via signal line 243.

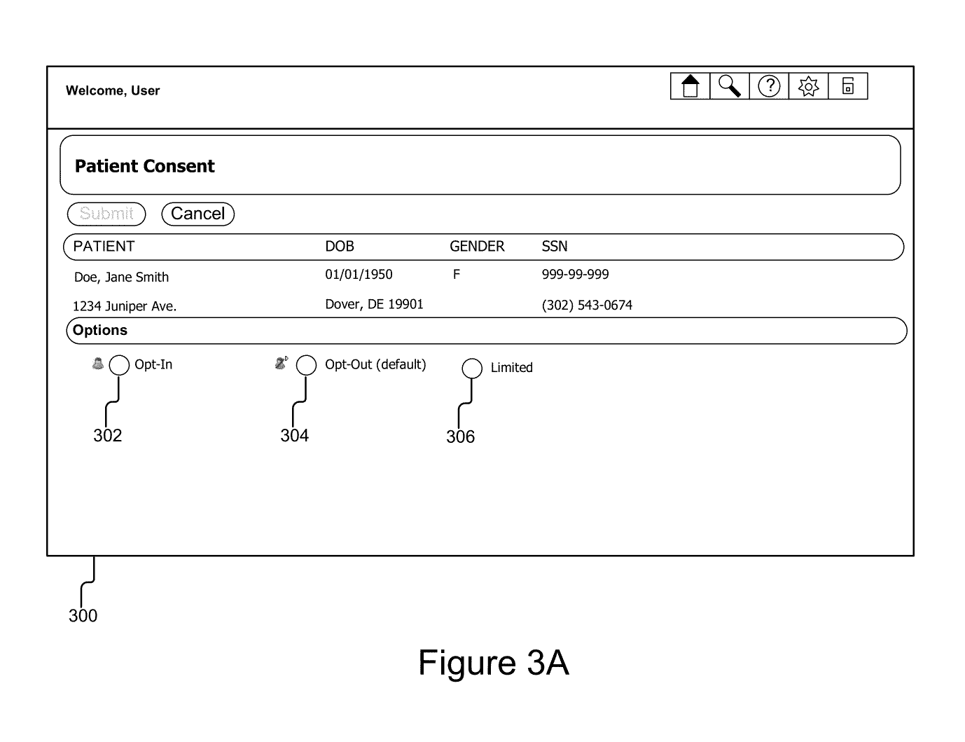

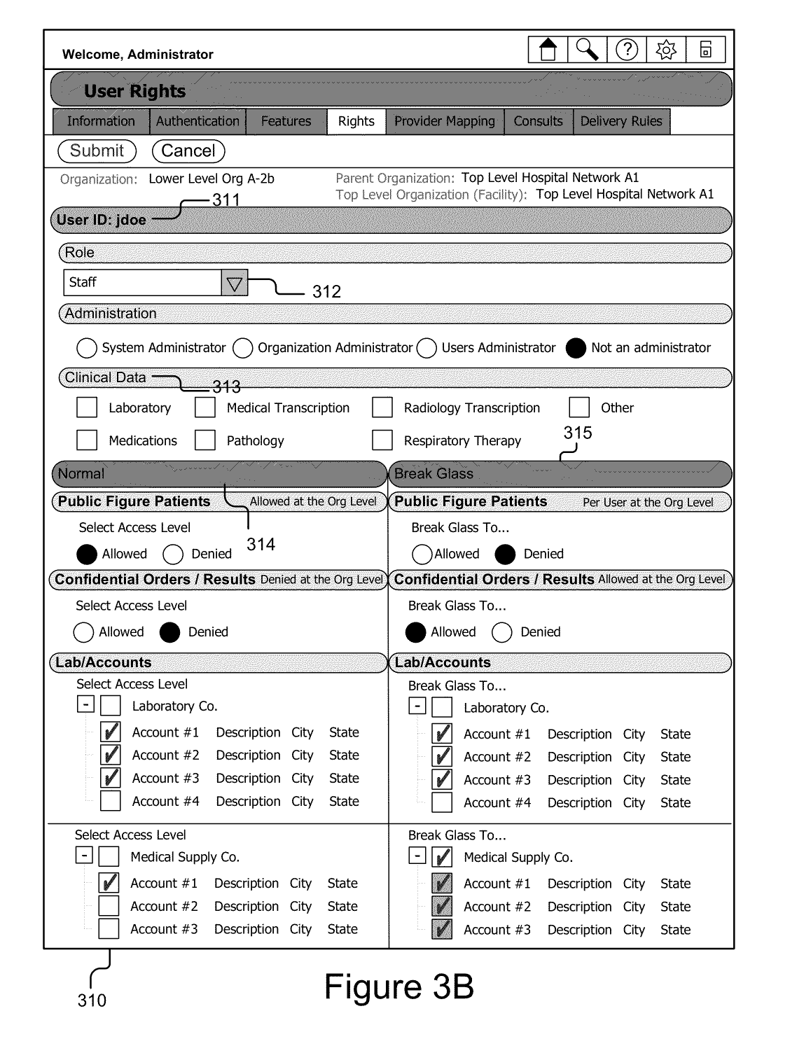

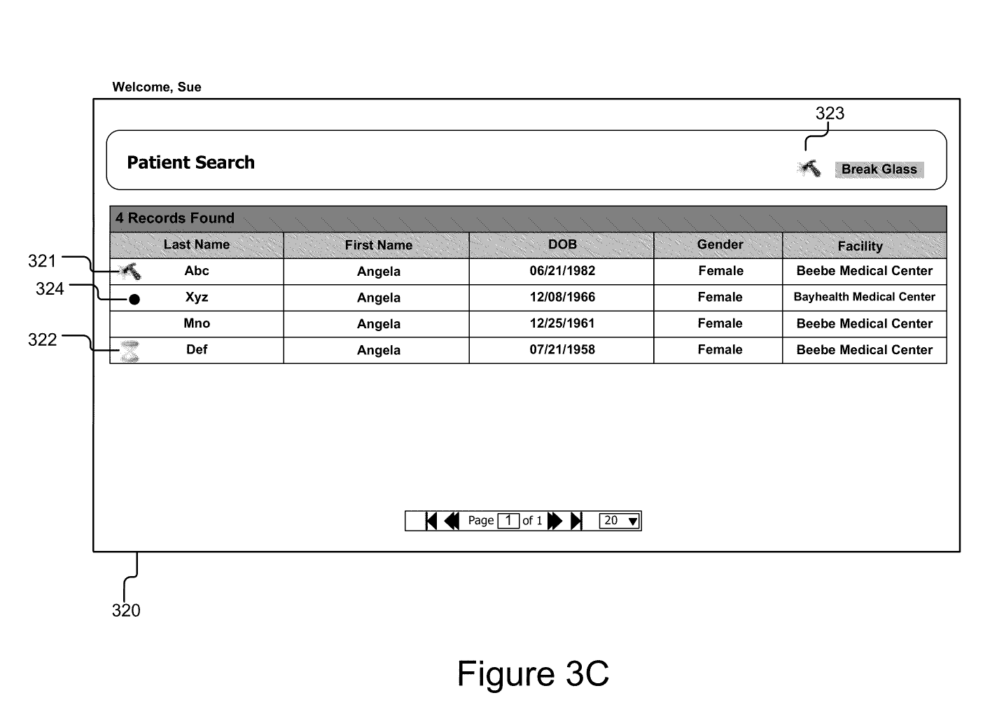

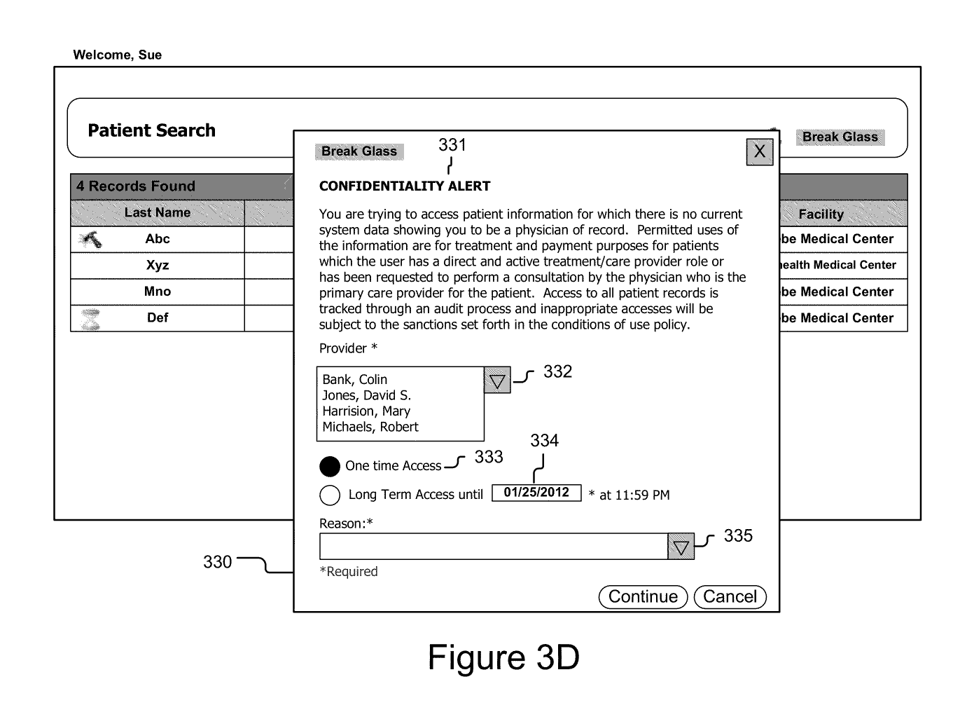

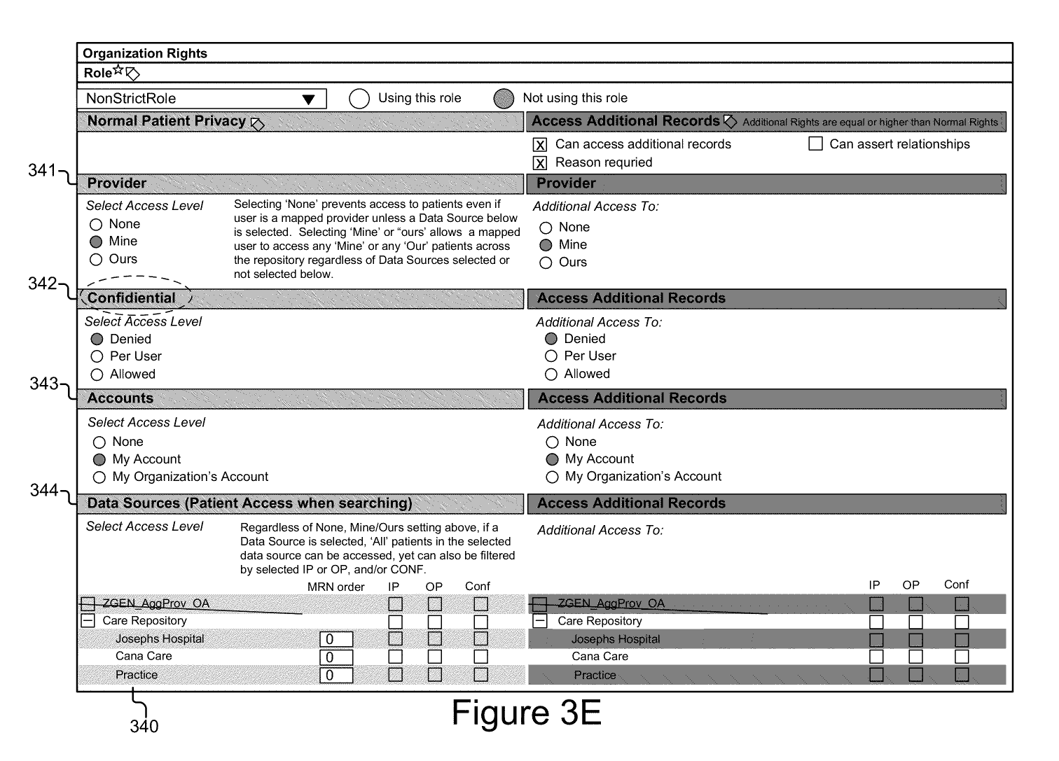

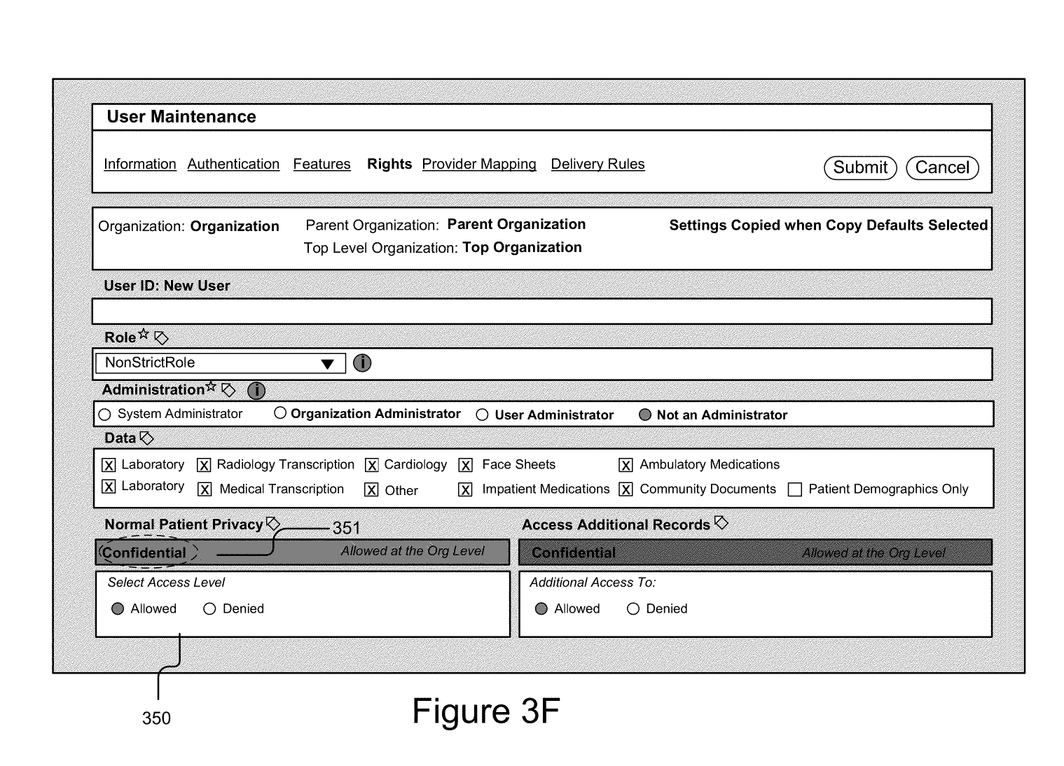

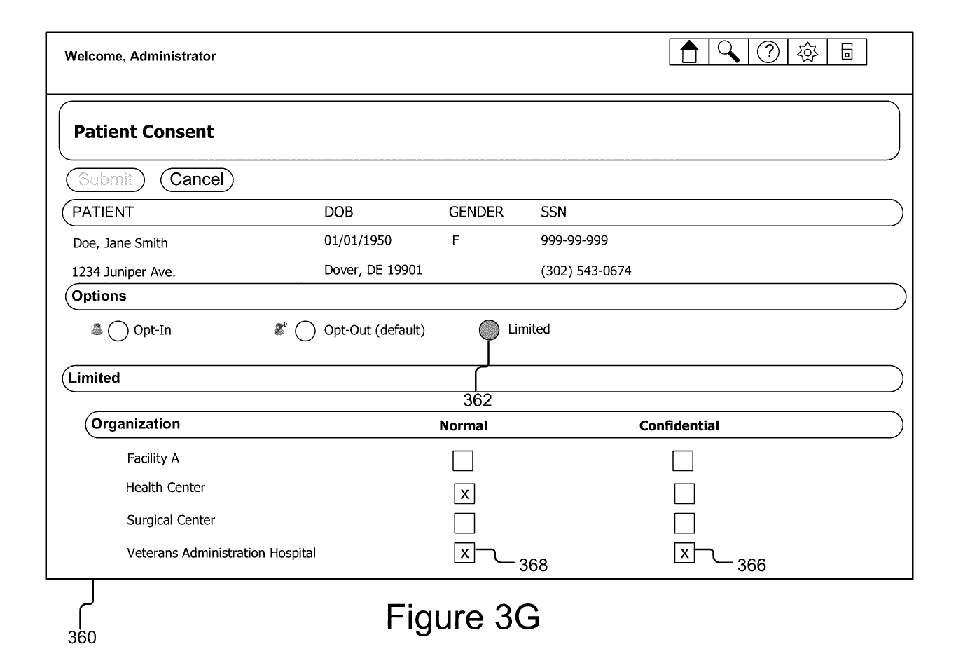

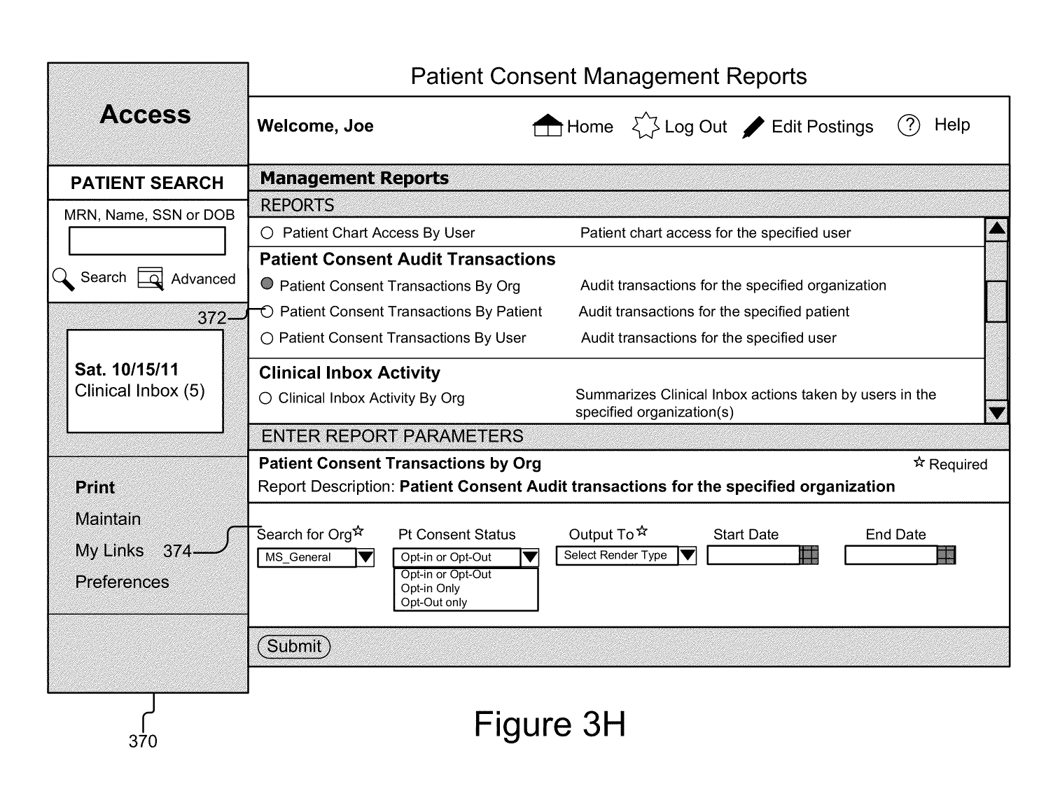

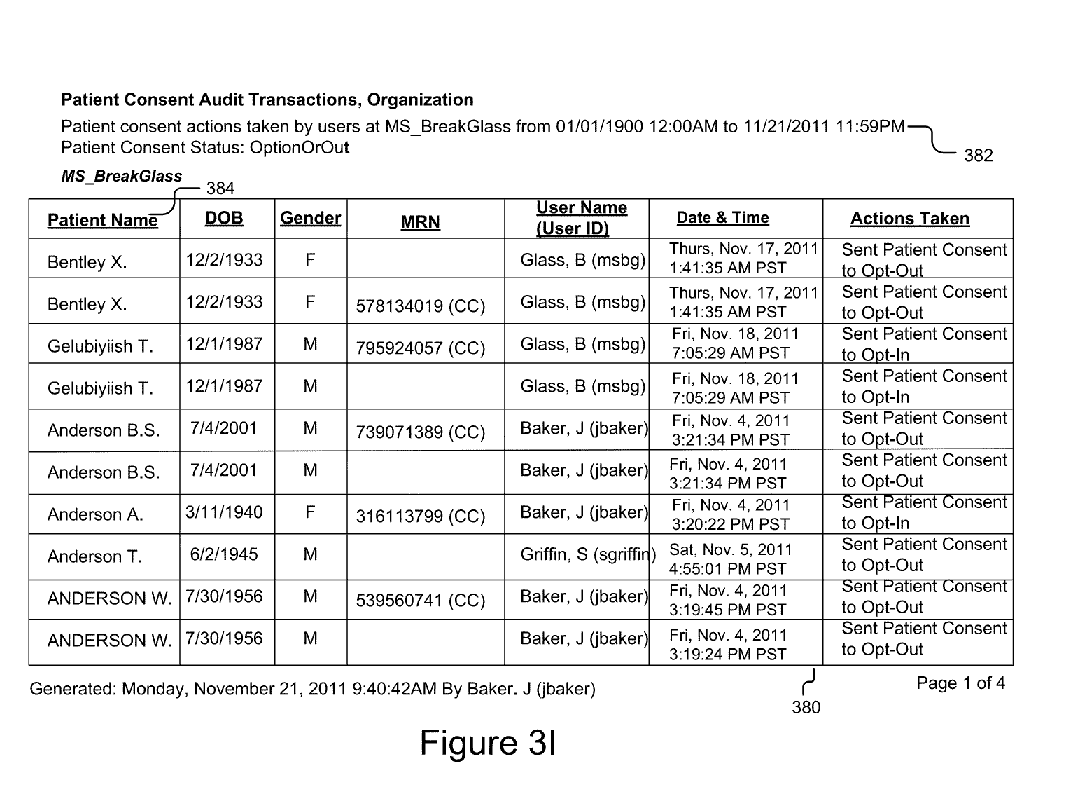

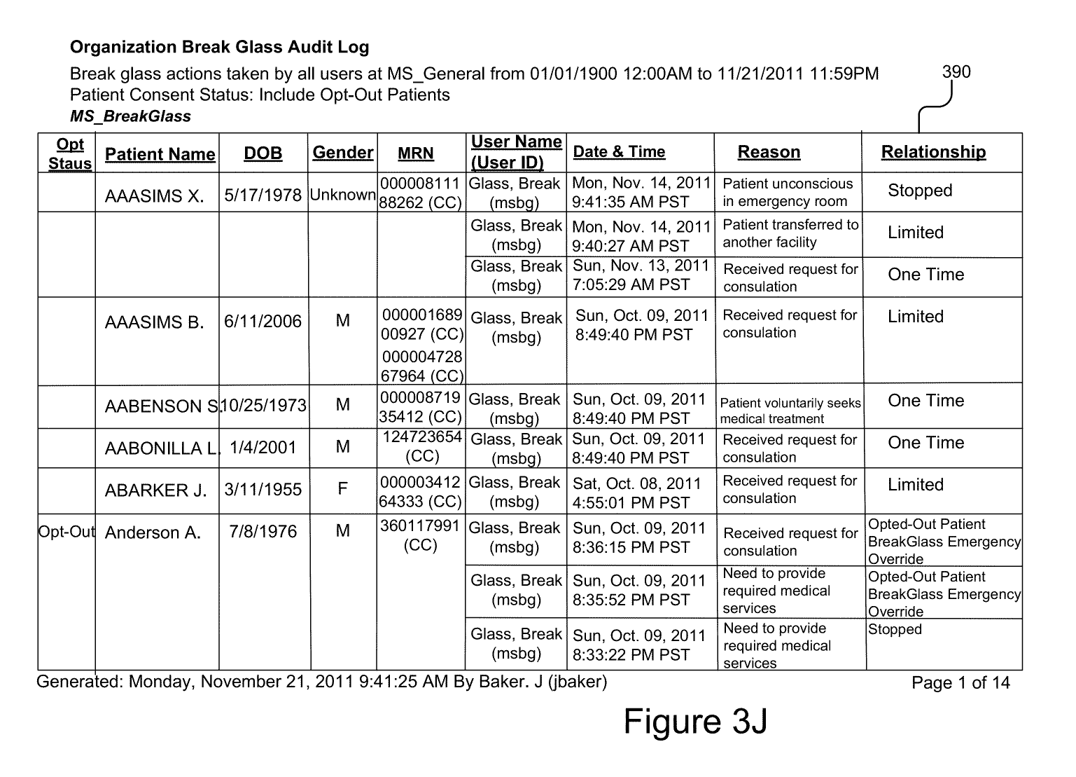

The user interface engine 212 generates a user interface according to instructions received from the authorization engine 203, the report module 207 and the user profile engine 201. In one embodiment, the user interface engine 212 receives consent status from a third-party application. The user opts-in with restrictions and opts-out with exceptions. The restrictions include a time limit, a provider and a data type. The user interface engine 212 is described in more detail below in reference to FIGS. 3A-3D.

FIG. 3A is a graphic representation 300 of a user interface for designating patient consent. Graphic representation 300 displays patient information and options for designating patient consent. A user, for example, a patient or an administrator acting on behalf of a patient designates patient consent by selecting one of a first option 302 to opt-in, a second option 304 to opt-out of sharing clinical data associated with the patient or a limited option 306. In some embodiments, the user is an administrator that transfers the user's preferences from a paper form or from verbal instructions. In some embodiments, the administrator also scans the physical consent form and the scanned form is viewable through the graphic representation 300.

The opt-in option 302 gives users access to the data. The opt-out option 304 restricts user access to the data. In some embodiments the system selects opt-out if the administrator fails to select an option. For example, if a patient does not designate an option to share clinical data, the default polity of the health care facility 125b that provided service to the patient could be to opt-out of sharing information. In FIG. 3A, the opt-out option 304 is the default policy for opting-out of sharing clinical data associated with the patient.

The limited option 306 can stricture user access for some users and provide access to others. For example, based on granular consent options, the patient's physicians can view the data but physicians that are unaffiliated with the patient cannot. In another example, the user could grant access to a subset of organizations or limit sharing of data from one facility. For example, a patient can choose to share all data from Hospital A with Hospital B, except for confidential drug treatment information about the patient. This does not mean, however, that all physicians at Hospital B can view the patient's information. The physician still needs to have the authority to access the information because the physician has been designated as the patient's physician.

FIG. 3B is a graphic representation 310 of a user interface for designating user rights. Graphic representation 310 displays user rights for accessing patient data. The user id 311 indicates that the user rights are for user “jdoe.” The user is assigned a role value 312 that sets default values for accessing patient data. In this embodiment, the role value 312 is staff but other options include attending, admitting and consulting physicians. In one embodiment, the default values are overridden by options under user right options 313, 314 and 315.

Options 313 determine whether a user is allowed to access various types of clinical data. For example, a user may be allowed to access lab work, medication history, pathology reports, etc. Options 314 determine whether the user is allowed to access VIP patient data, confidential orders and results and labs or accounts. Options 315 determines whether the user is allowed to access VIP status patient data, confidential orders and results and labs or accounts under an emergency or break glass situation.

FIG. 3C is a graphic representation 320 of a user interface for accessing patient data. Graphical icon 321 indicates that the user viewing the information does not have access to this patient's data and, as a result, would have to click on the graphical icon 321 to view the patient data associated with the line. The user clicks the graphical icon 321 to break glass to view the patient data. The user interface engine 212 receives the request and transmits the request to the authorization engine 203 and the auditing module 205. The authorization engine 203 determines whether the user is allowed to access the patient data. The auditing module 205 logs the breaking glass request. If the user is allowed to view the patient data, the user interface engine 212 generates a user interface that includes the patient data.

Graphical icon 322 indicates that a user previously broke glass in order to view patient data associated with patient in that row and the patient data is accessible for a period of time. When the authorization engine 203 receives the request to break glass, the user has the option to create a long term relationship with the patient. Therefore, the user is not required to subsequently break glass to access patient data associated with the patient at a later time.

Graphical icon 323 indicates that the user can break glass for patient search results. This could happen when a user searches for a patient and the results fail to include the patient. By breaking glass on search results, the user can view patient records for patients that exist outside the user's security rights, such as patient records marked as VIP or confidential.

Graphical icon 324 indicates that the patient selected to opt-in with restrictions to having data shared between organizations such that some of the information is inaccessible to the user.

FIG. 3D is a graphic representation 330 of a user interface for accessing confidential patient records using a break glass policy. Graphic representation 330 displays a confidentiality alert 331 to disclose permitted uses of information and to disclose that the user access is monitored. In the example, the user is required to identify a provider 332 that is treating the patient, an option for the timing of accessing the patient information and a reason 335 for accessing the patient information, such as because the physician is being consulted for a diagnosis. The user selects at least one of a one-time access option 333 and a long-term option 334. The long term option 334 requires a date/time when the access expires.

FIG. 3E is a graphic representation 340 of a user interface for designating user rights for accessing confidential data. An administrator of a health care related entity 125 can restrict or grant rights to view confidential data to a group of users. Users can be given normal access rights to view confidential data or can be given “access additional records” rights to break glass and view the confidential data as needed.

The user interface includes options 341-344 for assigning data access rights to a group of users associated with the health care related entity 125. The user interface includes a provider option 341 for granting access in different data sources. A user may select “None” to grant access to all patient data available in the selected data sources options 344 without breaking glass. The user may select “Mine” to limit access to just a user's patients or patients of the provider to whom that user is assigned in any data source even if it is not selected in the data source options 344. The user may select “Ours” to grant access to patients of all providers in the user's health care related entity 125 in any data source even if it not selected in the data source options 344.

The user interface further includes a confidential option 342 for granting/denying access to confidential data. The user may select “Denied” if no access to confidential data is allowed for users in the health care related entity 125. The user may select “Per User” to allow access to confidential data to be designated at the individual user level. The user may select “Allowed” for all user in the health care related entity 125 to have access to confidential data.

The user interface further includes an accounts option 343 for granting/denying access to accounts a user is able to see patient data from. The user may select “None” to restrict the user from viewing any patient data from any accounts. The user may select “My Accounts” if the user can access data associated with any account that the user has an association. The user may select “My Organization's Accounts” if the user can access patient data from all accounts mapped to any users in the health care related entity 125.

The user interface further includes the data sources option 344 for designating what data sources a user has access to and the specific encounter class or confidential status of the data from the source. If the user selects “IP” for a data source, the user is allowed access to inpatient data from the data source. If the user selects “OP” for a data source, the user is allowed access to outpatient data from the data source. If the user selects “Conf” for a data source, the user is allowed access to outpatient data from the data source. In one embodiment, the data sources option 344 override the provider option 341 and confidential option 342.

FIG. 3F is a graphic representation 350 of another user interface for designating user rights for accessing confidential data. The user interface includes a confidential option 351 for granting/denying a specific user access rights to confidential data. In one embodiment, the confidential option 351 is only available when the confidential option 342 in FIG. 3E is set at “Per User.”

FIG. 3G is a graphic representation 360 of a user interface for designating patient consent. Graphic representation 360 displays patient information and options for designating patient consent. A user or patient designates patient consent by selecting one of a first option to opt-in, a second option to opt-out and third option 362 to limit sharing clinical data associated with the patient. The user interface includes inputs for sharing the patient's information with one or more specific providers. A user may provide a selection to opt-in to sharing the patient's information with a specific provider. The user interface includes a first input 368 to opt-in to sharing normal patient information with a health care related entity 125 named “Veterans Administration Hospital.” In the example, the first input 368 is a checkbox that includes a mark that indicates consent to share the normal patient information with Veterans Administration Hospital. In one embodiment, normal patient information can be any non-confidential patient information. The user interface further includes a second input 366 to opt-in to sharing confidential patient information with the health care related entity 125.

FIG. 3H is a graphic representation 370 of a user interface for accessing patient consent audit transaction reports. Graphic representation 370 displays options 372 for accessing one or more types of reports related to patient consent audit transactions. In the illustrated example, a user may select one of the options 372 to access reports that include transaction data based on one of an organization, a patient and a user. The user interface includes report parameters 374 associated with a report. In one embodiment, the graphic representation 370 displays the reports parameters 374 based on the user selecting one of the options 372. In the illustrated embodiment, a user selected an option to view patient consent transactions by organization. The report parameters 374 include parameters associated with the report for generating the report. For example, the report parameters 374 include an input for specifying the organization, a consent status, report output type and date parameters. An example report based on the report parameters 374 is described in FIG. 3I.

FIG. 3I is a graphic representation 380 of a user interface of a patient consent audit transaction report. The patient consent audit transaction report includes parameters 382 for generating the patient consent audit transaction report. In the illustrated example, the report includes transaction information 384 associated with an organization. The parameters 382 include a parameter for specifying a specific organization. In one example, the parameters 382 were input by a user interacting with a user interface described in FIG. 3I. The transaction information 384 includes data related to patient consent. In the illustrated example, the patient consent audit transaction report includes patient information (e.g., name, date of birth, gender) user information (e.g., user id), date information and a description of a transaction.

FIG. 3J is a graphic representation 390 of a user interface of a data access audit log report according to one embodiment. The user interface includes a “Break Glass” report that includes break glass emergency override transactions. The report includes an opt status column for viewing the consent status. A break glass emergency override activity will display in the relations ship column of the report.

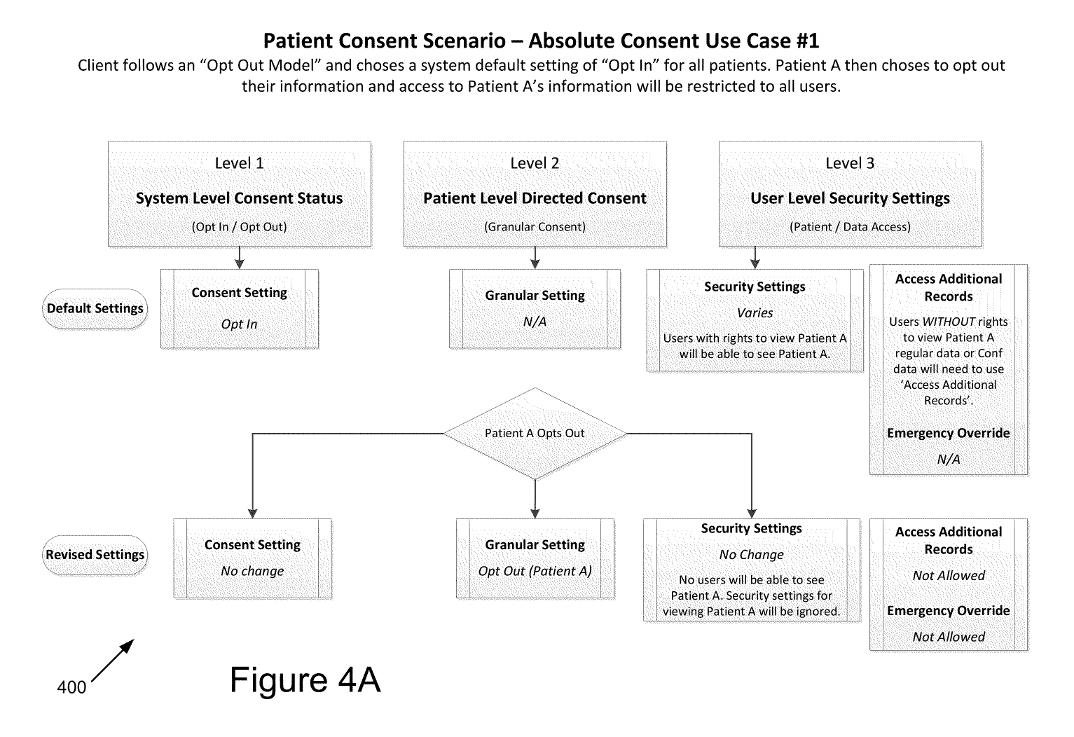

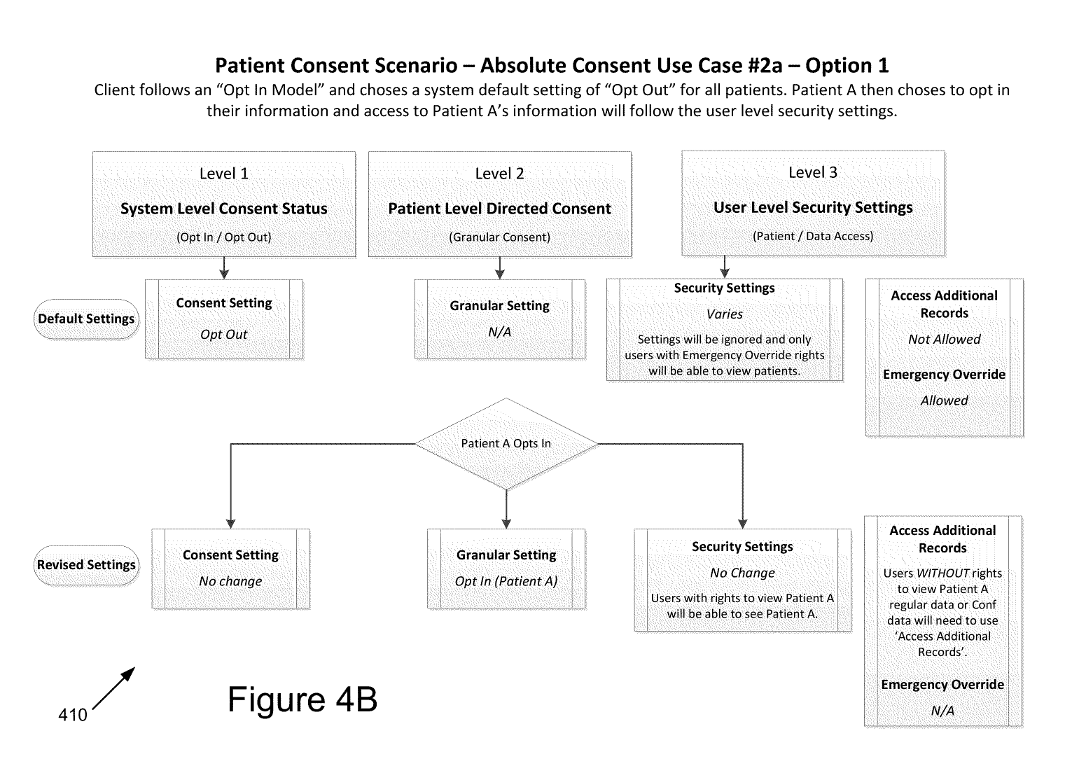

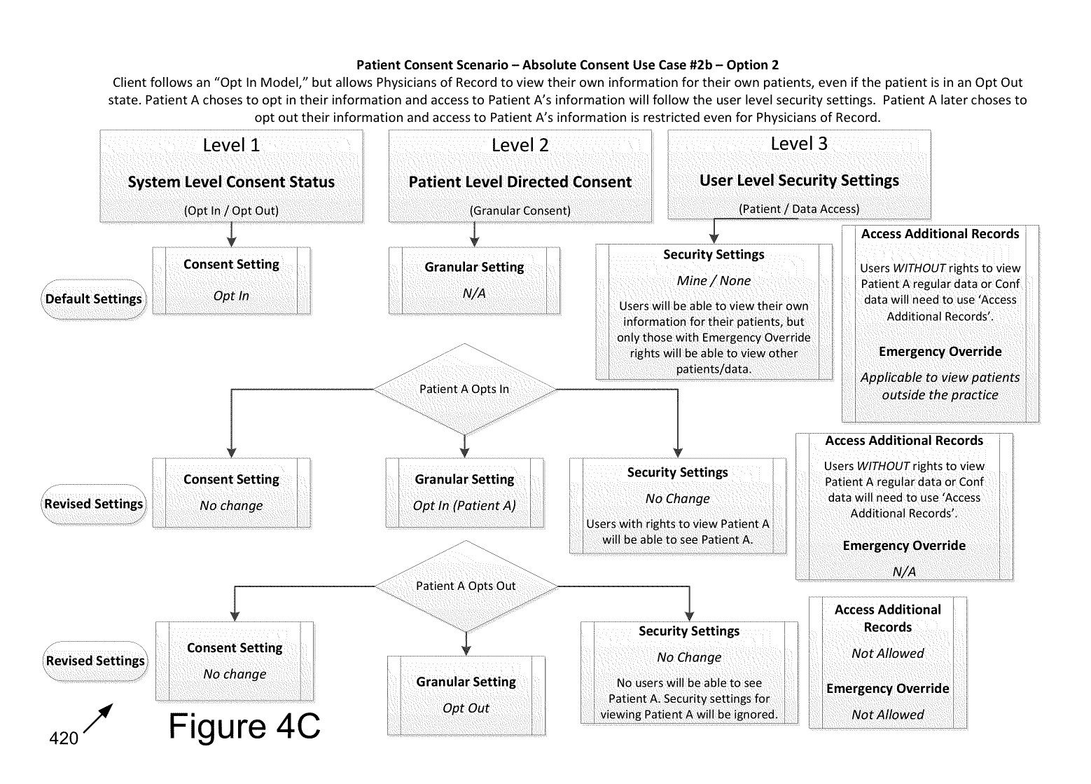

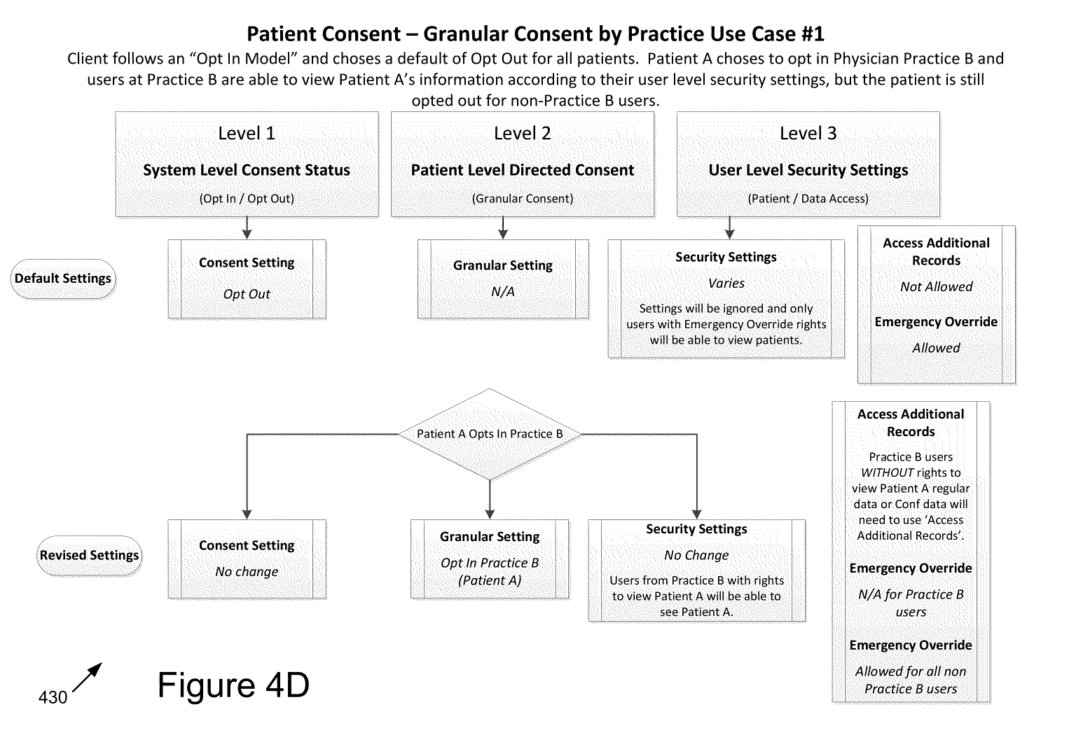

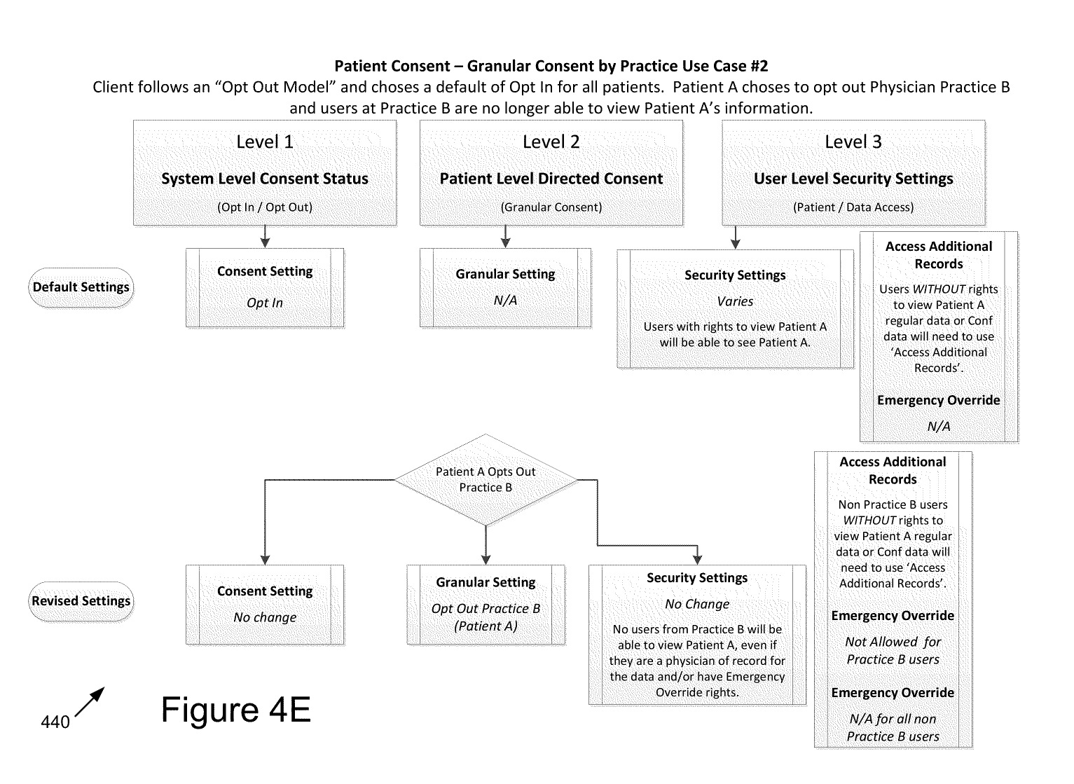

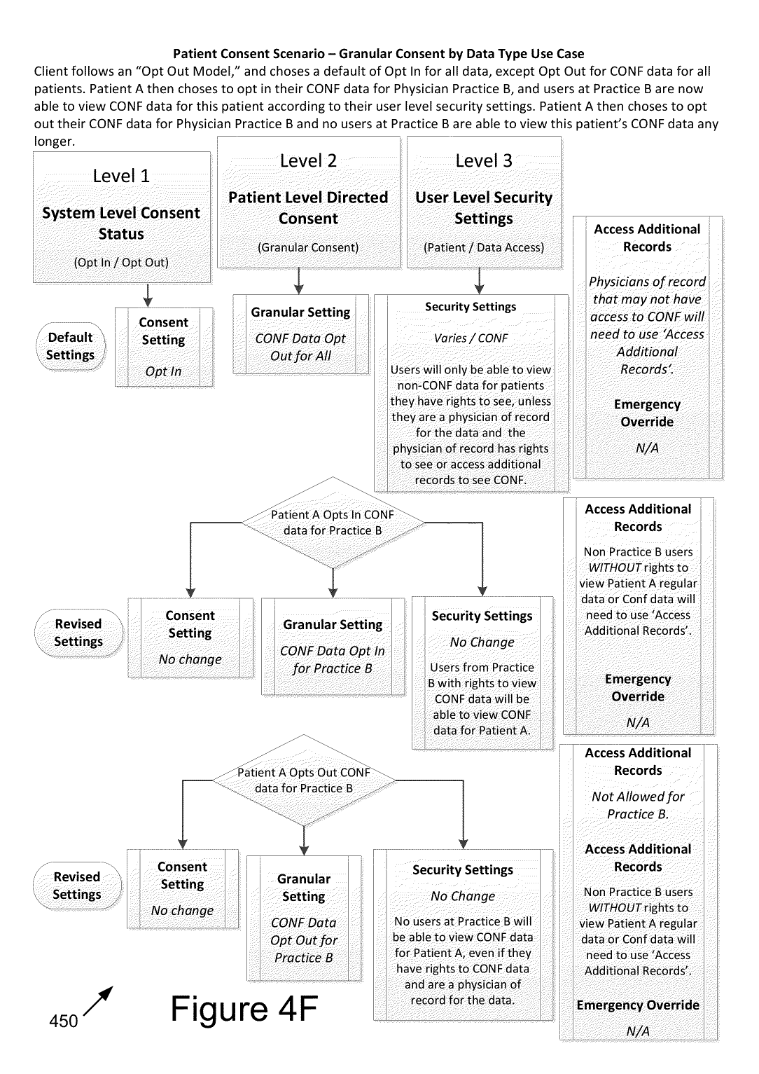

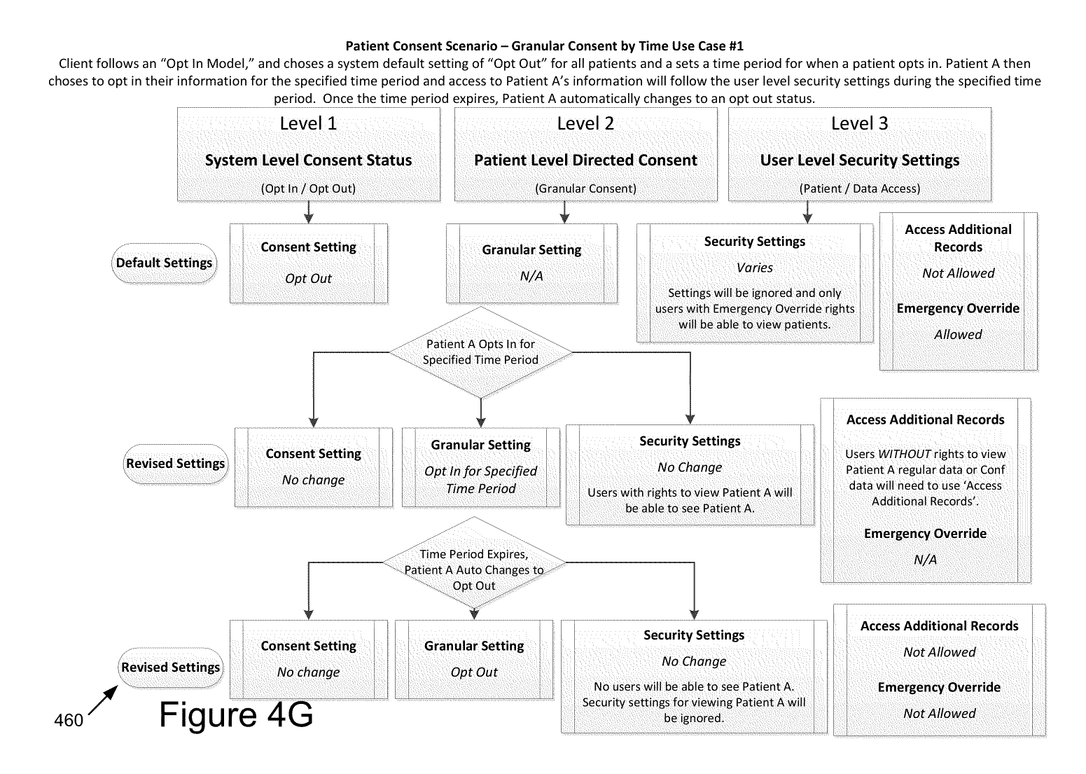

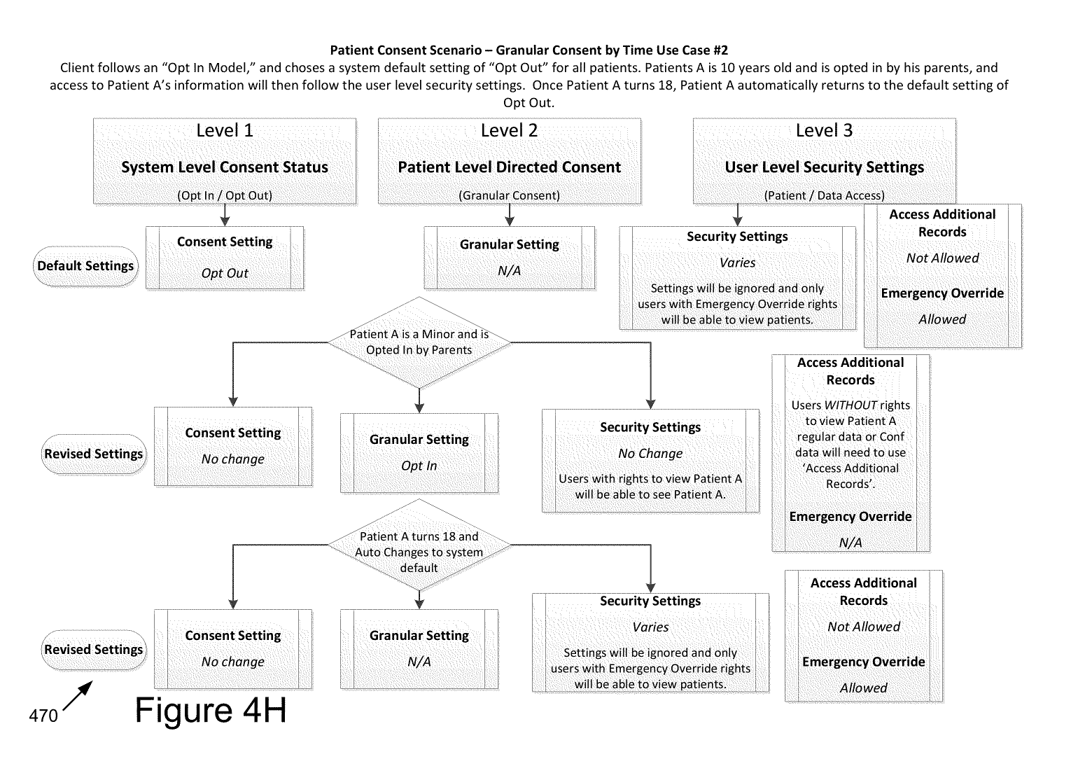

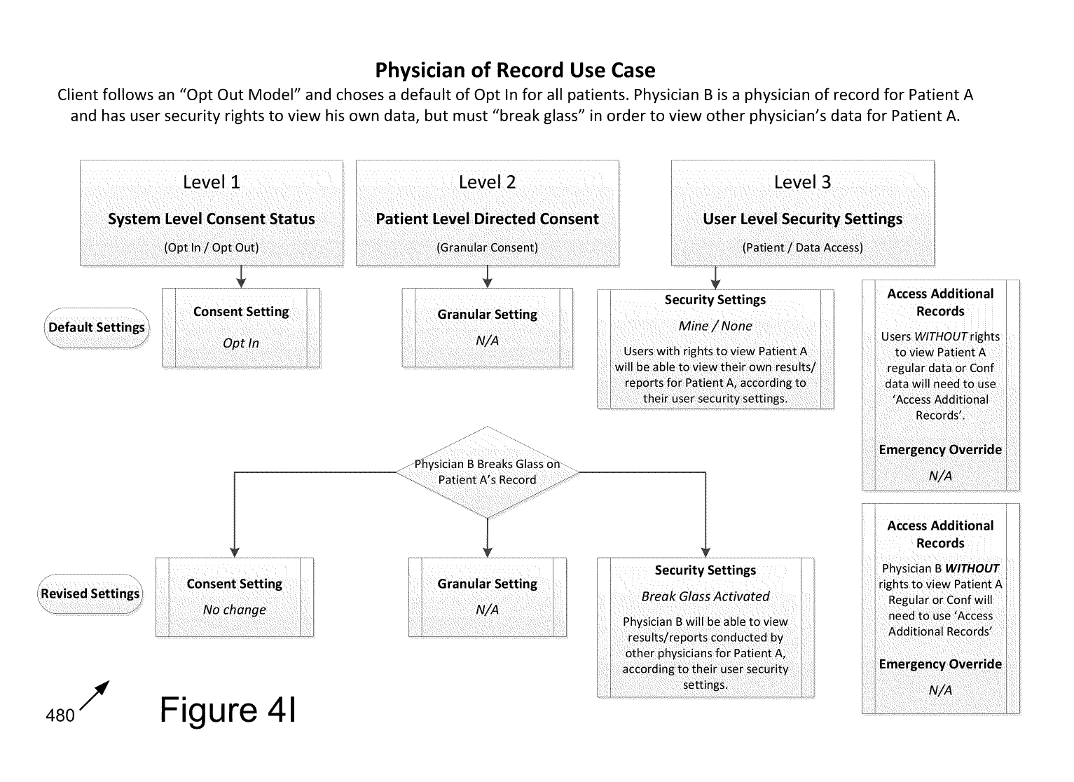

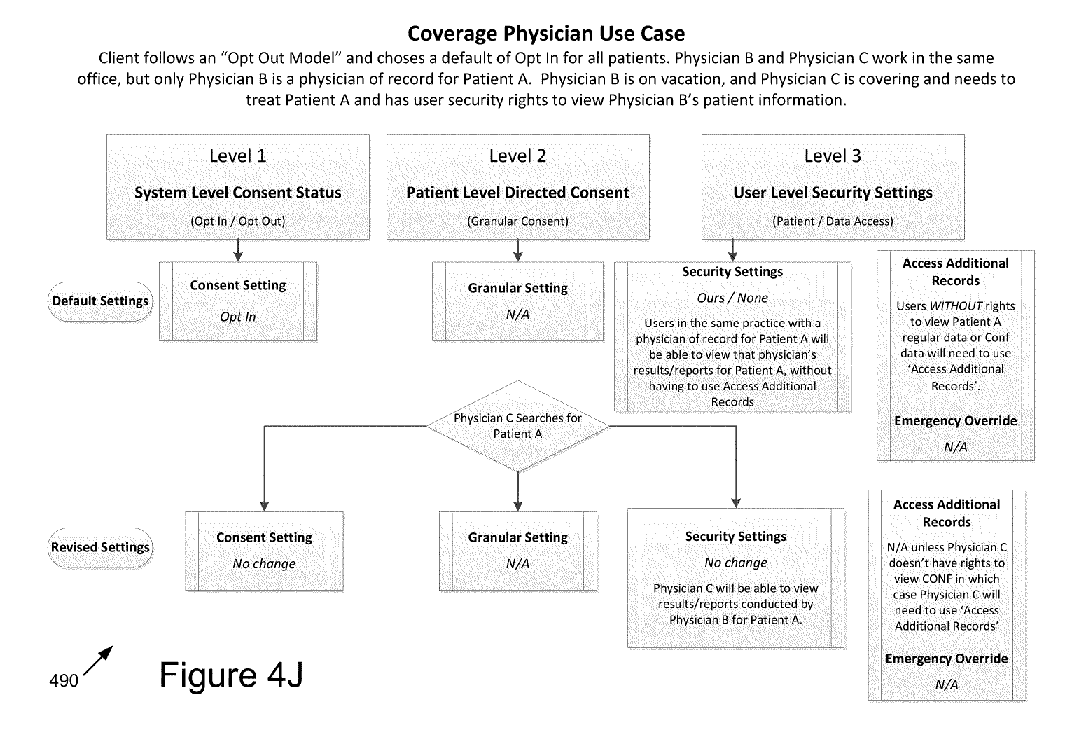

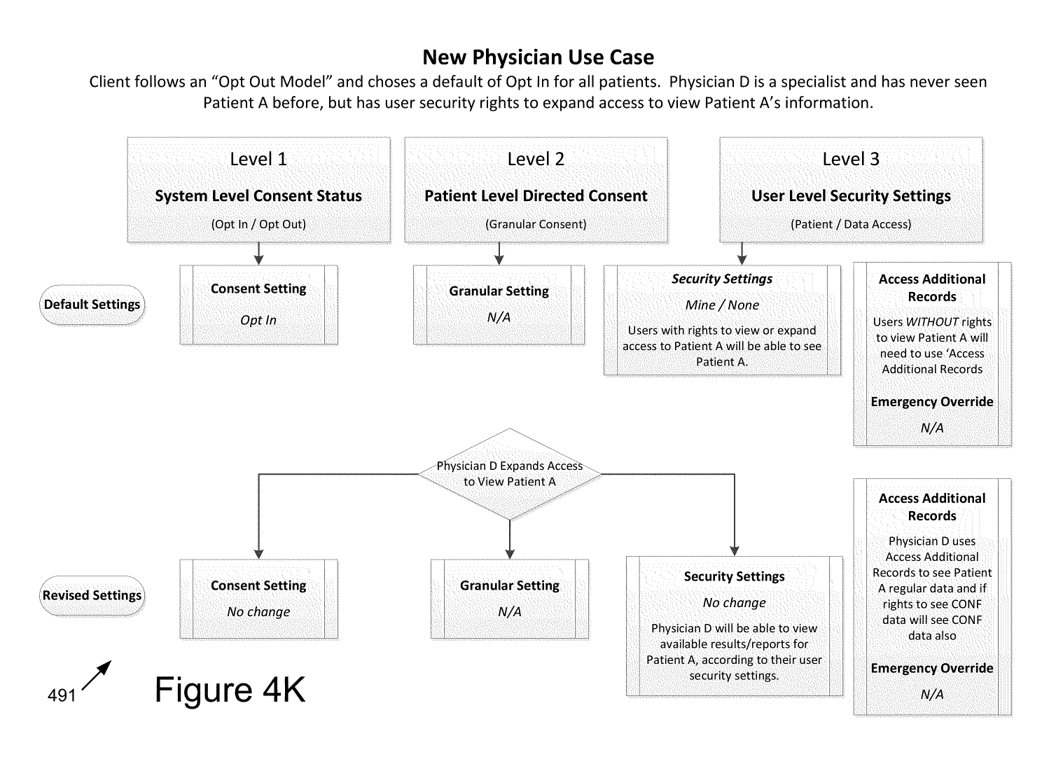

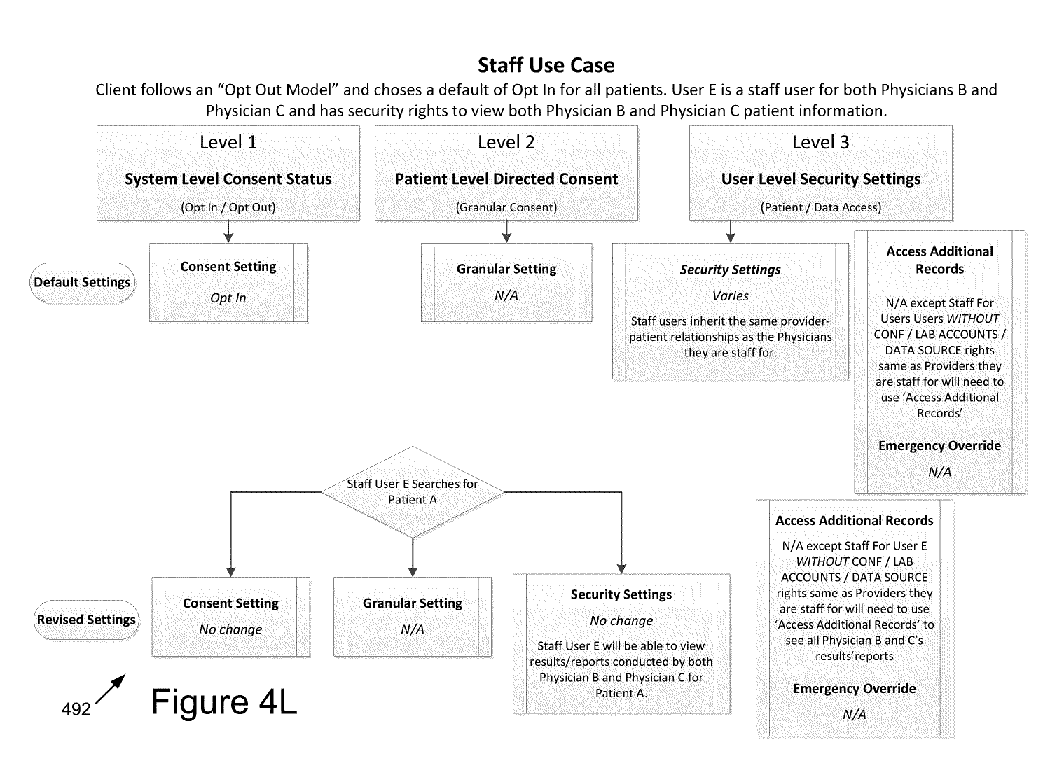

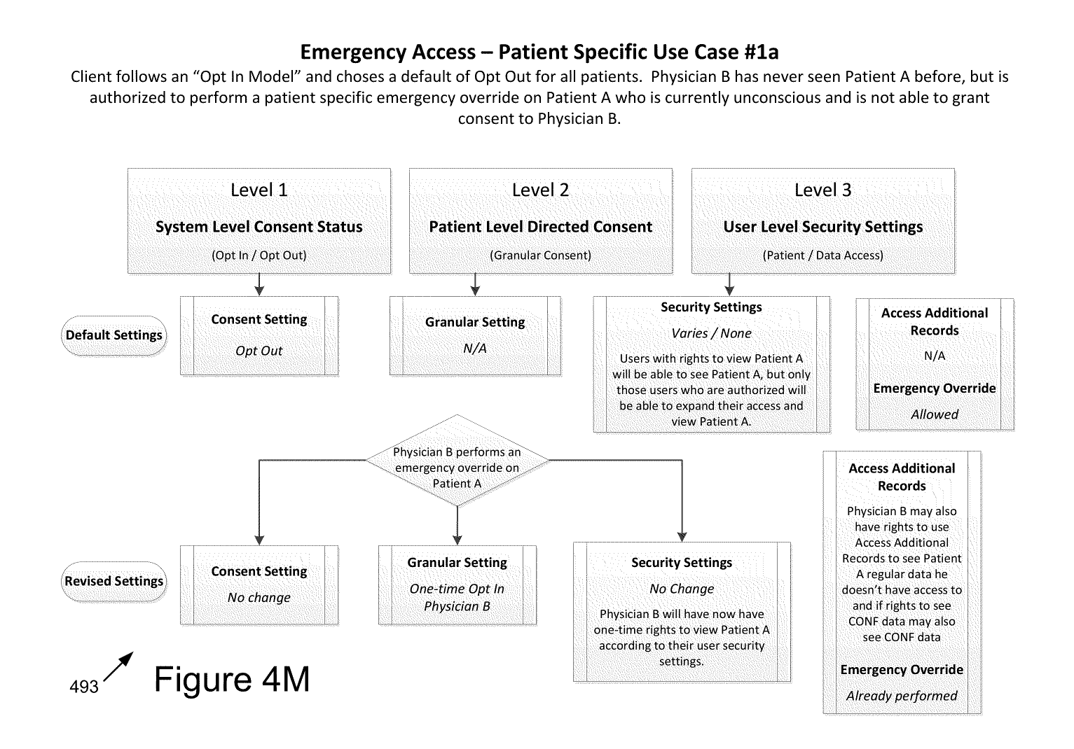

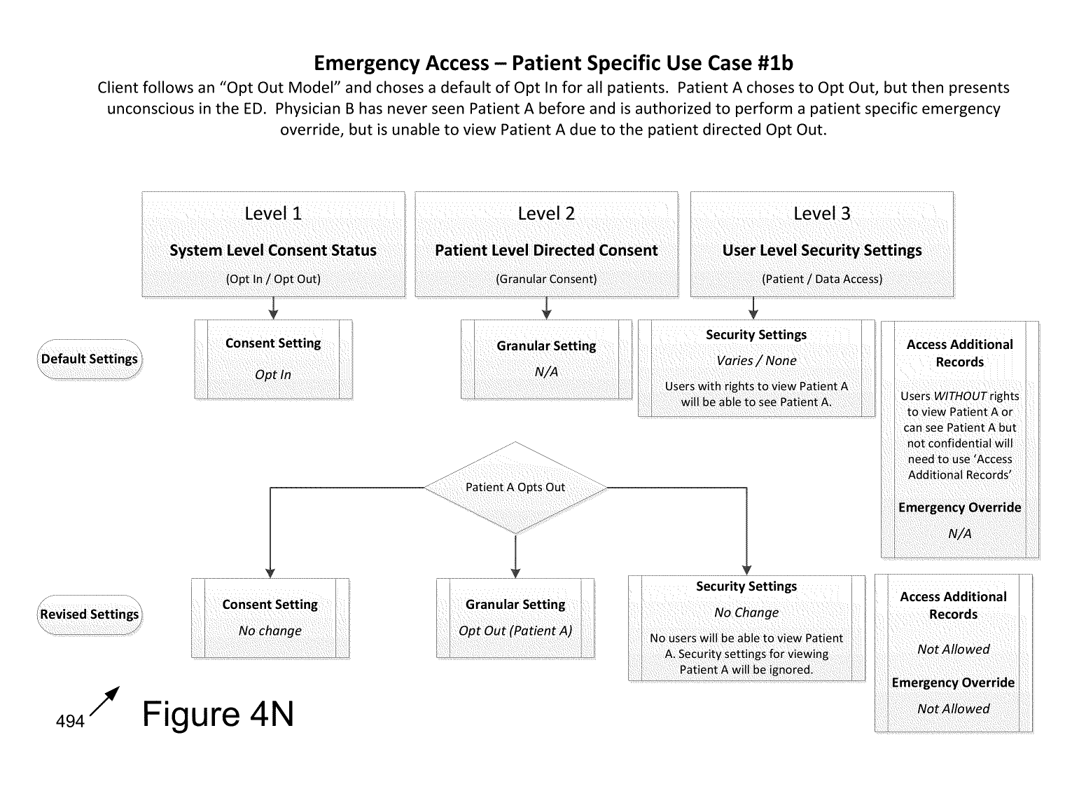

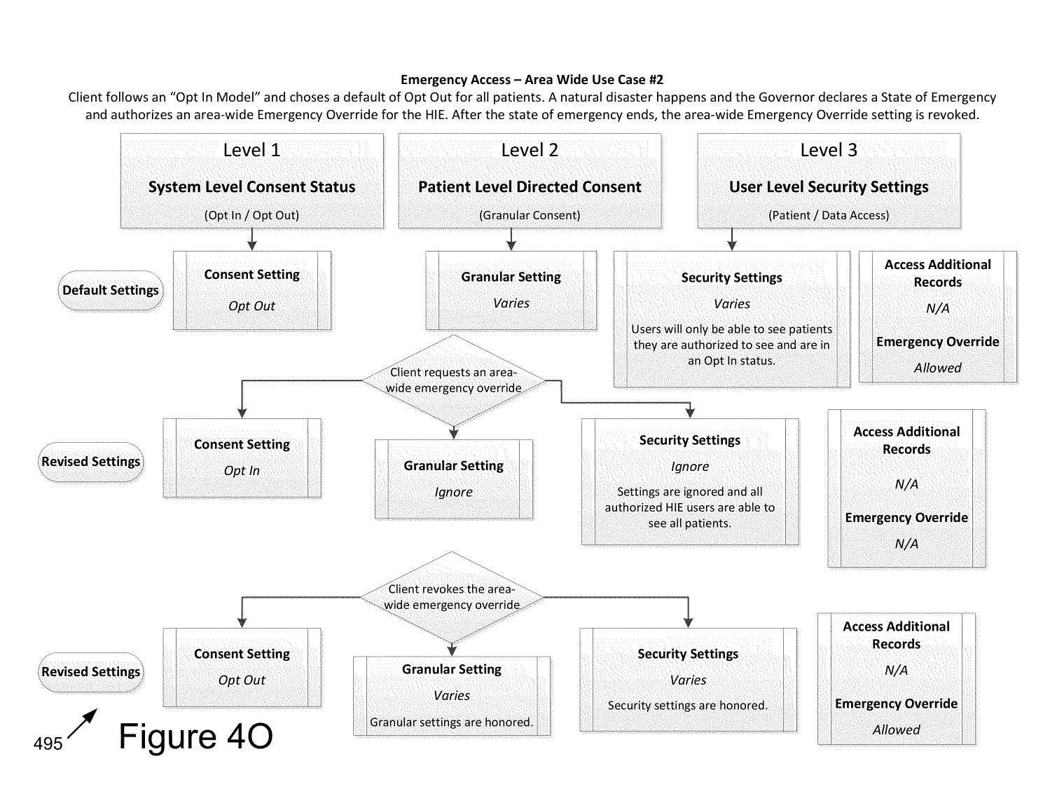

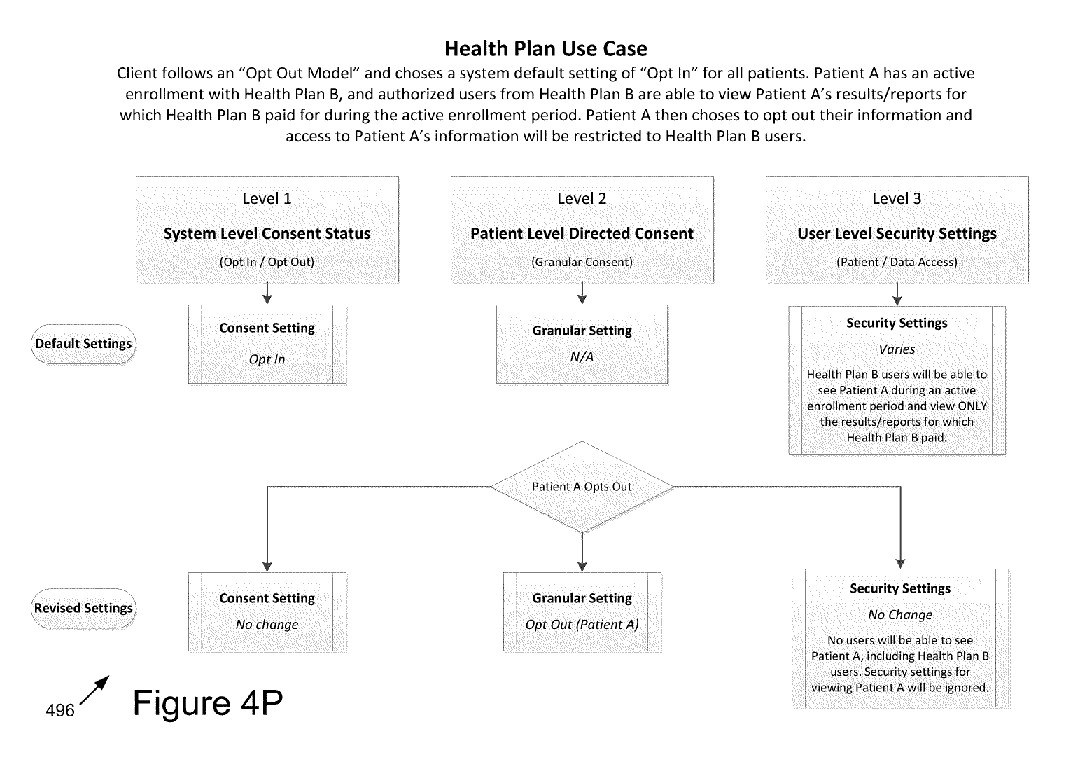

FIG. 4A is a graphic representation 400 of an example scenario for accessing patient data based on absolute consent. The scenario includes three levels of security framework layers. In the illustrated embodiment, the layers include a system level consent status, a patient level directed consent status and user level security settings. The scenario describes a health care related entity 125 following an “Opt Out Model” and selecting a system default setting of “opt in” for all patients. The default setting for all patients is a default absolute “opt in” status. Access to the patient's records follows the user level security settings for all users. Users with rights to view the patient's records will have access to the patient's records. Users without rights to view the patient record (e.g., regular data or confidential data) will need to use a “access additional records” method. Emergency override is not applicable for accessing the patient's records.

A patient may choose to “opt out” their information. Under this scenario, the patient is in a patient directed absolute “opt out” status. User level security settings are ignored and no user will be able to see the patient. Further, all users may not view the patient records using the “access additional records” method or emergency override.

If a patient is in a default absolute “opt out” state, the physician of record may still be able to access his/her patients and view only the reports/results for tests which they ordered/listed as a physician of record. Users with patient specific emergency override rights are able to perform an audited action and view the patient's record.

FIG. 4B is a graphic representation 410 of another example scenario for accessing patient data based on absolute consent. The scenario includes three levels of security framework layers. In the illustrated embodiment, the layers include a system level consent status, a patient level directed consent status and user level security settings. The scenario describes a health care related entity 125 following an “Opt in Model” and selecting a system default setting of “opt out” for all patients. The default setting for all patients is a default absolute opt out status. User level security settings are ignored and only users with emergency override rights can view the patients. Further, users may not use a “access additional records” method to access the patient records.

A patient may choose to “opt in” their information. Users with the rights to view the patient's records will be able to access the patient's records. Users without rights to view the patient's records (e.g., regular and confidential data) will need to use a “access additional records” method. Users without rights to the patient's records may not use emergency override to access the patient's records. If the patient is in a default absolute “opt in” status, access to the patient's record also follows the user level security settings of the user.

FIG. 4C is a graphic representation 420 of another example scenario for accessing patient data based on absolute consent. The scenario includes three levels of security framework layers. In the illustrated embodiment, the layers include a system level consent status, a patient level directed consent status and user level security settings. The scenario describes a health care related entity 125 following an “Opt in Model” and selecting a system default setting of “opt in” for all patients. Physicians of Record may view their own information for their own patients even if the patient is in an “opt out” state. Users without rights to view a patient's record (e.g., regular or confidential data) will need to user a “access additional records” method. The emergency override may be applicable to view patients outside the health care related entity 125.

A patient may choose to “opt in” their information. Users with the rights to view the patient's records will be able to access the patient's records. Users without rights to view the patient's records (e.g., regular and confidential data) will need to use a “access additional records” method. Users without rights to the patient's records may not use emergency override to access the patient's records.

A patient may choose later to “opt out” their information. No users will be able to view the patient's records. Security settings for viewing the patient's records are ignored. Users may not use the “access additional records” method or the emergency override to view the patient's records.

FIG. 4D is a graphic representation 430 of example scenario for accessing patient data by granular consent by practice. The scenario includes three levels of security framework layers. In the illustrated embodiment, the layers include a system level consent status, a patient level directed consent status and user level security settings. The scenario describes a health care related entity 125 following an “Opt in Model” and selecting a system default setting of “opt out” for all patients. Physicians of Record may view their own information for their own patients even if the patient is in an “opt out” state. Users without rights to view a patient's record (e.g., regular or confidential data) will need to user a “access additional records” method. The emergency override may be applicable to view patients outside the health care related entity 125. The default setting for all patients is a default absolute opt out status. User level security settings are ignored and only users with emergency override rights can view the patients. Further, users may not use a “access additional records” method to access the patient records.

A patient may choose to “opt in” their information for viewing by a particular health care related entity 125. Users at the particular health care related entity 125 with rights to view the patient's records will be able to see the patient's records. Users at the particular health care related entity 125 without rights to view the patient's records will need to use a “access additional records” method. Users at the particular health care related entity 125 without rights to the patient's records may not use emergency override to access the patient's records. The patient is still “opted out” for other health care related entities 125 different from the particular health care related entity 125. If the patient is in a system default “opt out” and a physician has emergency override access rights, the physician will be able to perform an audited action and access the patient's record without first obtaining consent form the patient.

FIG. 4E is a graphic representation 440 of another example scenario for accessing patient data based on granular consent by practice. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patients. The default setting for all patients is a default absolute “opt in” status. Access to the patient's records follows the user level security settings for all users. Users with rights to view the patient's records will have access to the patient's records. Users without rights to view the patient record (e.g., regular data or confidential data) will need to use a “access additional records” method. Emergency override is not applicable for accessing the patient's records.

A patient may choose to “opt out” their information for viewing by a particular health care related entity 125 and “opt in” status for other health care related entities 125. No users from the particular health care related entity 125 will be able to view the patient's records. Further, the physician of record for the patient at the particular health care related entity 125 will not be able to view the patient. Emergency override rights may not be used to view the patient. All physicians and staff users will be able to view the patient's record at the other health care related entities 125 according to their user security settings.

FIG. 4F is a graphic representation 450 of example scenario for accessing patient data based on granular consent by type of data. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patient data, except for “opt out” for confidential data for all patients. Users will only be able to view non-confidential data, (e.g., normal data) for patients they have rights to see, unless they are a physician of record for the patient data. The physician of record has rights to see or access additional records to see the confidential data. Emergency override is not applicable for accessing the patient's records.

In one embodiment, a patient may choose to “opt in” their confidential data for particular health care related entity 125. Users at the particular health care related entity 125 with rights to view confidential data will be able to view the patient's confidential data. Users at the particular health care related entity 125 without rights to view confidential data can view the patient's confidential data by using the “access additional records” method. Emergency override is not applicable for accessing the patient's records at the particular health care related entity 125.

In another embodiment, the patient may choose to “opt out” their confidential data for the particular health care related entity 125. Now, users at the particular health care related entity 125 will not be able to view the patient's confidential data. Even if the users have rights to confidential data and are a physician of record of the data, the user will still not have access to the confidential data. Users at health care related entities 125 different from the particular health care related entity 125 may access the patient's confidential data using the “access additional records” method.

FIG. 4G is a graphic representation 460 of example scenario for accessing patient data based on patient consent and time. The scenario includes three levels of security framework layers. In the illustrated embodiment, the layers include a system level consent status, a patient level directed consent status and user level security settings. The scenario describes a health care related entity 125 following an “Opt in Model” and selecting a system default setting of “opt out” for all patients and sets a time period when a patient “opts in.” User level security settings are ignored and only users with emergency override rights can view the patients. Further, users may not use a “access additional records” method to access the patient records.

A patient may choose to “opt in” their patient information for the specified time period. Users with the rights to view the patient's records will be able to access the patient's records. Users without rights to view the patient's records (e.g., regular and confidential data) will need to use a “access additional records” method. Users without rights to the patient's records may not use emergency override to access the patient's records.

Once the time period expires, the “opt in” status is changed to an “opt out status.” User level security settings are ignored and no user will be able to see the patient. Further, all users may not view the patient records using the “access additional records” method or emergency override.

FIG. 4H is a graphic representation 470 of another example scenario for accessing patient data based on patient consent and time. The scenario includes three levels of security framework layers. In the illustrated embodiment, the layers include a system level consent status, a patient level directed consent status and user level security settings. The scenario describes a health care related entity 125 following an “Opt in Model” and selecting a system default setting of “opt out” for all patients. User level security settings are ignored and only users with emergency override rights can view the patients. Further, users may not use a “access additional records” method to access the patient records.

A patient, who is a minor (e.g., 10 years old), is “opted in” by his parents. Users with the rights to view the patient's records will be able to access the patient's records. Users without rights to view the patient's records (e.g., regular and confidential data) will need to use a “access additional records” method. Users without rights to the patient's records may not use emergency override to access the patient's records.

Once the patient becomes an adult (e.g., 18 years old), the patient automatically returns to the default setting of the system, “opt out.” User settings are ignored and only users with emergency override rights may see the patient's information. Further, all users may not view the patient records using the “access additional records” method.

FIG. 4I is a graphic representation 480 of example scenario for accessing patient data of another physician of record. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patients. Access to the patient's records follows the user level security settings for all users. Users with rights to view the patient's records will have access to the patient's records. Users without rights to view the patient record (e.g., regular data or confidential data) will need to use a “access additional records” method. Emergency override is not applicable for accessing the patient's records.

A physician of record for a patient has rights to view the physician's data related to the patient. The physician must “breaks glass” to access the patient's records of another physician. The physician can view results/reports conducted by other physicians for the patient according to their user security settings. The physician without rights to view the patient record (e.g., regular data or confidential data) will need to use a “access additional records” method. Emergency override is not applicable for accessing the patient's records. There are a number exceptions. For example, patient directed opted out results would not be available for the physician to view even if the ordered the test. In another example, if the patient has a directed absolute “opt out” status, then the patient name would not be visible in a patient search, regardless if the physician has emergency override access rights.

FIG. 4J is a graphic representation 490 of example scenario for accessing patient data by a covering physician. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patients. Access to the patient's records follows the user level security settings for all users. Users with rights to view the patient's records will have access to the patient's records. Users in the same practice with a physician of record for a patient have rights to view the physician of record's results/reports for the patient without using a “access additional records” method. Users without rights to view the patient record (e.g., regular data or confidential data) will need to use a “access additional records” method. Emergency override is not applicable for accessing the patient's records. For example, the physician of record for a patient may be on vacation. Another physician covering for the physician of record needs to treat the patient and has user security rights to view the physician of records information for the patient. The other physician may not have the rights to view confidential information. Thus, the other physician must use a “access additional records” method to access the patient's confidential information.

FIG. 4K is a graphic representation 491 of example scenario for accessing patient data by a new physician. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patients. Access to the patient's records follows the user level security settings for all users. Users with rights to view the patient's records will have access to the patient's records. Users in the same practice with a physician of record for a patient have rights to view the physician of record's results/reports for the patient without using a “access additional records” method. Users without rights to view the patient record (e.g., regular data or confidential data) will need to use a “access additional records” method. Emergency override is not applicable for accessing the patient's records. A specialist physician who has never treated a patient has rights to expand access to view the patient's information. The specialist may use a “access additional records” method to view the patient's regular data. If the specialist has the rights to see confidential data, the specialist may use the “access additional records” method to view the patient's confidential data. There are a few exceptions in the scenario. For example, patient directed “opted out” results would not be available to the physician to view. Also, if the patient chose an absolute “opt out,” then the patient name would not be visible in a patient search either. In another example, if the physician did not have security rights to view confidential results, the confidential results would not be available to the physician.

FIG. 4L is a graphic representation 492 of example scenario for accessing patient data by a staff user. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patients. Access to the patient's records follows the user level security settings for all users. Users with rights to view the patient's records will have access to the patient's records. Staff users inherit the same provider-patient relationships as the physician that they are staff for. A staff user without rights to view confidential data, lab accounts, data source will need to use a “access additional records” method. Emergency override is applicable for accessing the patient's records by the staff user only if the patient is in default “opt out” and the physician has patient specific emergency override rights. When a staff user searches for a patient, the staff user will be able to view results/reports conducted by any physician for the patient. A staff user without rights to view confidential data, lab accounts, data source will need to use a “access additional records” method to access that data. Patient “opted out” results would not be available for the staff user to view. There are a few exceptions in the scenario. For example, patient directed “opted out” results would not be available to the staff user to view. Also, if the patient chose an absolute “opt out,” then the patient name would not be visible in a patient search either. In another example, if the staff user did not have security rights to view confidential results, the confidential results would not be available to the staff user.

FIG. 4M is a graphic representation 493 of example scenario for accessing patient data using emergency access. The scenario includes three levels of security framework layers. In the illustrated embodiment, the layers include a system level consent status, a patient level directed consent status and user level security settings. The scenario describes a health care related entity 125 following an “Opt In Model” and selecting a system default setting of “opt out” for all patients. Access to the patient's records follows the user level security settings for all users. Users with rights to view the patient's records will have access to the patient's records. Users with rights to view a patient have rights to see the patient, but only those users who are authorized will be able to expand their access and view the patient. Providers with emergency access rights should be able to view patients which they are not a physician of record. This may or may not require the physician to perform an audited action to view the patient's records. Only system default “opted out” patients are eligible.

A patient in an emergency situation may be unconscious and not able to grant consent to an emergency physician. The physician has never seen the patient before, but is authorized to perform a patient specific emergency override on the patient. The physician performs the emergency override and will have one-time rights to view the patient according the physician's user security settings. The physician may also use a “access additional records” to view regular data for the patient. If the physician has rights to view confidential data, they physician may use the “access additional records” method for viewing the confidential data. There are a few exceptions. For example, patient directed “opted out” results would not be available for the physician to view. Also, if the patient chose an absolute “opt out,” then the patient's name would not be visible in a patient search either.

FIG. 4N is a graphic representation 494 of another example scenario for accessing patient data using emergency access. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patient data. Users with rights to view the patient's records will have access to the patient's records. Users without rights to view the patient record (e.g., regular data or confidential data) will need to use a “access additional records” method. Emergency override is not applicable for accessing the patient's records.

A patient may choose to “opt out,” but then presents unconscious in the emergency department. An emergency physician has never seen the patient before, but is authorized to perform a patient specific emergency override on the patient. The physician is unable to view the patient due to the patient directed “opt out.”

FIG. 4O is a graphic representation 495 of another example scenario for accessing patient data using emergency access. The scenario includes three levels of security framework layers. In the illustrated embodiment, the layers include a system level consent status, a patient level directed consent status and user level security settings. The scenario describes a health care related entity 125 following an “Opt In Model” and selecting a system default setting of “opt out” for all patients. Users will only be able to see patients that the user is authorized to see and that are in an “opt in” status.

A health care related entity 125 may request an area-wide emergency override. The override changes all patient records in the area to an “opt in” state. All Health Information Exchange users are able to see all patients, regardless of current user security settings. Once the emergency is over, the setting can be switched back to the previous consent and security settings.

FIG. 4P is a graphic representation 496 of an example scenario for accessing patient data by a health plan user. The scenario includes three levels of security framework layers. In the illustrated embodiment, the layers include a system level consent status, a patient level directed consent status and user level security settings. The scenario describes a health care related entity 125 following an “Opt out Model” and selecting a system default setting of “opt in” for all patient data. A health plan user has access to view patients during an active enrollment period and view only the results/reports for which the health plan paid for during the current or previous enrollment periods. Patient directed “opted out” results would not be available for the health plan user to view. If the patient chose an absolute “opt out,” then the patient name would not be visible in a patient search either. The health plan user will not be able to see reports/results they did not pay for, regardless if they occurred during the active enrollment period. Also, confidential results would not be available if the health plan user did not have rights to view the confidential results.

### Example Flowcharts

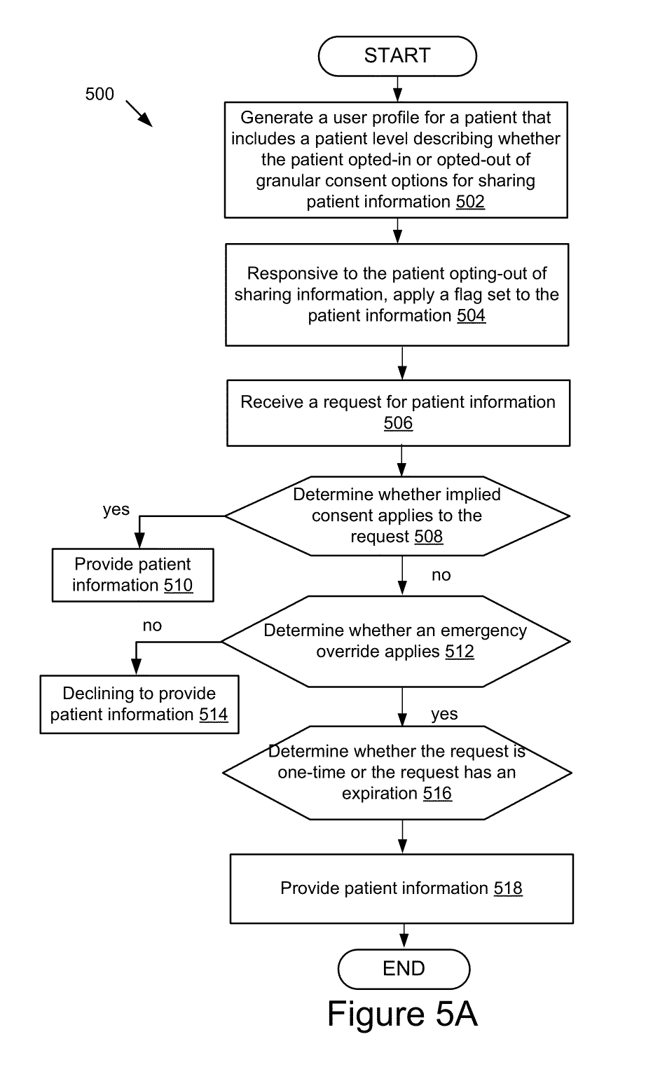

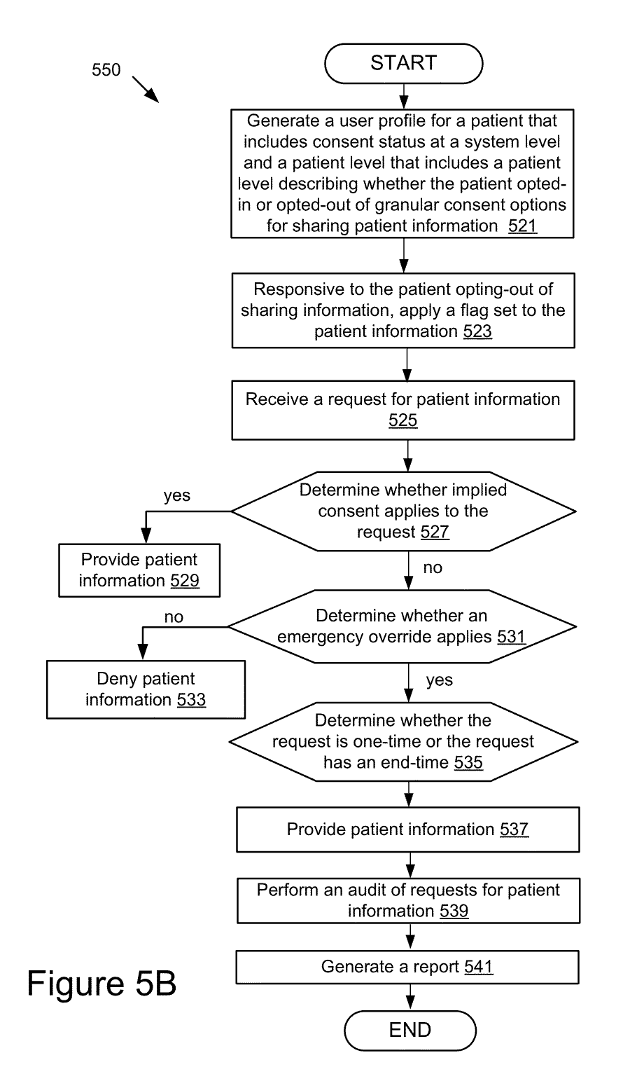

FIG. 5A is an example flowchart 500 that illustrates a method for determining whether a requestor can access patient information. The data access manager 103 comprises a user profile engine 201, a lookup module 202 and an authorization engine 203.

The user profile engine 201 generates 502 a user profile for a patient that includes a patient level describing whether the patient opted-in or opted-out of granular consent options for sharing patient information. For example, the user profile includes limitations on data type, provider, time range or purpose of the data. The lookup module 202 receives 504 a request for patient information and retrieves patient information. The authorization engine 203 identifies 506 that the patient opted-out of sharing patient information. For example, the user profile includes a limitation that users cannot view patient information from a veteran hospital. The authorization engine 203 determines 508 whether implied consent applies to the request. For example, if the user requesting data is the user's physician. If there is implied consent, the authorization engine 203 provides 510 patient information, for example, by instructing the user interface engine 212 to generate graphical data for displaying the requested information. If no, the authorization engine 203 determines 512 whether an emergency override applies. For example, the authorization engine 203 determines whether the physician works in the emergency room of a hospital. If no, the authorization engine 203 declines 514 to provide patient information. If yes, the authorization engine 203 determines 516 whether the request is one-time or the request has an expiration date. For example, a state-wide emergency could have an expiration period of two weeks and if the time has expired, the authorization engine 203 declines to provide the patient information. If these restrictions do not apply, the authorization engine 203 provides 518 the patient information.

FIG. 5B is an example flowchart 550 that illustrates a method for determining whether a requestor can access patient information and generating a report. The data access manager 103 comprises a user profile engine 201, a lookup module 202, an authorization engine 203, an auditing module 205, a report module 207 and a user interface engine 212.

The user profile engine 201 generates 523 a user profile for a patient that includes consent status at a system level and a patient level describing whether the patient opted-in or opted-out of granular consent options for sharing patient information. For example, the system level uses an opt-out consent status as a default. The lookup module 202 receives 523 a request for patient information and retrieves patient information. The authorization engine 203 identifies 525 that the patient opted-out of sharing patient information. The authorization engine 203 determines 527 whether implied consent applies to the request. If there is implied consent, the authorization engine 203 provides 529 patient information, for example, by instructing the user interface engine 212 to generate graphical data for displaying the requested information. If no, the authorization engine 203 determines 531 whether an emergency override applies. If no, the authorization engine 203 declines 533 to provide patient information. If yes, the authorization engine 203 determines 535 whether the request is one-time or the request has an expiration date. If these restrictions do not apply, the authorization engine 203 provides 518 the patient information.

The auditing module 205 performs 539 an audit of requests for patient information. For example, the audit can be based on an organization (e.g. a hospital), a patient (e.g. patient ID 95343) or a user (e.g. Dr. Ross). In some embodiments, the auditing module 205 performs the audit regularly (e.g. at the first of every month) or in response to a trigger (e.g. in response to a user exceeding a threshold number of requests to break glass over a period of time). The report module 207 generates 541 a report.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the disclosure be limited not by this detailed description, but rather by the claims of this application. As will be understood by those familiar with the art, the invention may be embodied in other specific forms without departing from the spirit or essential characteristics thereof. Likewise, the particular naming and division of the modules, routines, features, attributes, methodologies and other aspects are not mandatory or significant, and the mechanisms that implement the invention or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the invention, which is set forth in the following claims.

1. A computer-implemented method comprising:
generating, with one or more processors, a user profile for a patient that includes a patient level describing whether the patient opted-in or opted-out of granular consent options for sharing patient information;
receiving a request for patient information;
determining, with the one or more processors, whether implied consent applies to the request;
responsive to implied consent being inapplicable to the request, determining whether an emergency override applies, declining to provide the patient information;
responsive to the emergency override applying, determining whether the request is one-time or the request has an end-time; and
providing the patient information.

2. The method of claim 1, wherein responsive to the request having an expiration and the expiration having occurred, declining to provide the patient information.

3. The method of claim 1, wherein the user profile also includes a system level consent status for opting-in or opting-out of providing patient data by default.

4. The method of claim 1, wherein the granular consent option includes consent regarding a data type, a healthcare provider, a time range and a purpose.

5. The method of claim 1, further comprising responsive to the user having implied consent, providing the patient information.

6. The method of claim 1, further comprising:
performing an audit of requests for patient information based on a patient, users associated with an organization that requested the patient information or a user that requested the patient information; and
generating a report based on the audit.

7. The method of claim 6, further comprising notifying an administrator responsive to a number of requests for patient data exceeding a threshold number during a fixed period of time.

8. The method of claim 6, wherein the emergency override is for patients within a geographical area.

9. The method of claim 1, wherein the patient is automatically opted-out based on being designated as a very important person.

10. A system comprising:
a memory; and
a user profile engine stored on the memory and executed by one or more processors, the user profile engine generating a user profile for a patient that includes a patient level describing whether the patient opted-in or opted-out of granular consent options for sharing patient information;
a lookup module coupled to the user profile engine, the lookup module receiving a request for patient information; and
an authorization engine coupled to the lookup module, the authorization engine determining whether implied consent applies to the request, responsive to implied consent failing to apply to the request, determining whether an emergency override applies, declining to provide the patient information, responsive to the emergency override applying, determining whether the request is one-time or the request has an end-time and providing the patient information.

11. The system of claim 10, wherein responsive to the request having an expiration and the expiration having occurred, declining to provide the patient information.

12. The system of claim 10, wherein the user profile also includes a system level consent status for opting-in or opting-out of providing patient data by default.

13. The system of claim 10, wherein the granular consent option includes consent regarding a data type, a healthcare provider, a time range and a purpose.

14. The system of claim 10, wherein the authorization engine is further configured to provide the patient information responsive to the user having implied consent.

15. The system of claim 10, further comprising:
an auditing module coupled to the authorization module, the auditing module performing an audit of requests for patient information based on a patient, users associated with an organization that requested the patient information or a user that requested the patient information; and
a reporting module coupled to the auditing module, the reporting module generating a report based on the audit.

16. A computer program product comprising a non-transitory computer readable program, wherein the computer readable program when executed on a computer causes the computer to:
generate a user profile for a patient that includes a patient level describing whether the patient opted-in or opted-out of granular consent options for sharing patient information;
receive a request for patient information;
determine whether implied consent applies to the request;
responsive to implied consent being inapplicable to the request, determine whether an emergency override applies, declining to provide the patient information;
responsive to the emergency override applying, determine whether the request is one-time or the request has an end-time; and
prove the patient information.

17. The computer program product of claim 16, wherein responsive to the request having an expiration and the expiration having occurred, declining to provide the patient information.

18. The computer program product of claim 16, wherein the user profile also includes a system level consent status for opting-in or opting-out of providing patient data by default.

19. The computer program product of claim 16, wherein the granular consent option includes consent regarding a data type, a healthcare provider, a time range and a purpose.

20. The computer program product of claim 16, wherein the authorization engine is further configured to provide the patient information responsive to the user having implied consent.
